(19) United States
(12) Patent Application Publication
(10) Pub. No.: US 2016/0054508 A1
(43) Pub. Date: Feb. 25, 2016

(54) LIGHTING DEVICE AND DISPLAY DEVICE

(71) Applicant: SHARP KABUSHIKI KAISHA, Osaka-shi (JP)

(72) Inventors: Yoshinobu HIRAYAMA, Osaka-shi (JP); Hiroshi FUKUSHIMA, Osaka-shi (JP); Ryoh ARAKI, Osaka-shi (JP); Shugo YAGI, Yonago-shi (JP); Masaki KAGEYAMA, Yonago-shi (JP); Toru INATA, Yonago-shi (JP)

(21) Appl. No.: 14/780,663

(22) PCT Filed: Mar. 27, 2014
(86) PCT No.: PCT/JP2014/058783

§ 371 Date: Sep. 28, 2015

(30) Foreign Application Priority Data
Mar. 29, 2013 (JP) 2013-072189

(51) Int. Cl. F21V 8/00

(52) U.S. Cl. CPC G02B 6/0055; G02B 6/0038; G02B 6/0053

(57) ABSTRACT

A backlight unit includes LEDs, a light guide plate, a reflection sheet, a prism sheet, and an anisotropic reflection portion. The light guide plate includes a light entrance surface opposed to the LEDs and light exit surface. The reflection sheet includes a reflection surface opposed to an opposite plate surface of the light guide plate opposite from the light exit surface. The prism sheet is formed on a side of the light guide plate opposite from a side on which the reflection sheet is disposed. The prism sheet includes unit prisms that extend along a first direction and are arranged parallel to one another along a second direction. The anisotropic reflection portion includes unit reflectors disposed on the reflection surface of the reflection sheet. The unit reflectors extend along the first direction and are arranged parallel to one another along the second direction.

### TECHNICAL FIELD

The present invention relates to a lighting device and a display device.

### BACKGROUND ART

Display components in image display devices, such as television devices, are now shifting from conventional cathode-ray tube displays to thin display panels, such as liquid crystal panels and plasma display panels. With the thin display panels, the thicknesses of the image display devices can be reduced. Liquid crystal panels included in the liquid crystal display devices do not emit light, and thus backlight devices are required as separate lighting devices. The backlight devices are generally classified into direct-type and edge-light-type according to mechanisms. An edge-light-type backlight device includes a light guide plate for guiding light from a light source and an optical member for converting the light from the light guide plate to even planar light with optical properties and for supplying the light to a liquid crystal panel. An example of such a device is disclosed in Patent Document 1. Patent Document 1 discloses a configuration that includes multiple cylindrical lenses arranged parallel to one another on a light exit surface of a light guide plate such that the light guide plate has light collecting properties. The configuration further includes a prism sheet arranged on a light exit surface side.

### RELATED ART DOCUMENT

### Patent Document

Patent Document 1: International Publication No. 2012/050121

### Problem to be Solved by the Invention

In the above Patent Document 1, a light collecting direction of the cylindrical lenses on the light exit surface of the light guide plate is aligned with that of the prism sheet on the light exit surface to enhance light collecting performance. If brightness of the backlight device needs to be improved, sufficient light collecting performance may not be achieved from the above configuration. Namely, more improvement is required.

### Disclosure of the Present Invention

The present invention was made in view of the foregoing circumstances. An object is to improve brightness.

### Means for Solving the Problem

A lighting device according to the present invention includes a light source, a light guide plate, a reflection member, an anisotropic light collecting portion, and an isotropic reflection portion. The light guide plate has a rectangular plate-like shape and includes peripheral surfaces opposite from each other and plate surfaces. At least one of the peripheral surfaces is configured as a light entrance surface opposite the light source. One of the plate surfaces is configured as a light exit surface. The reflection member includes a reflection surface opposed to the plate surface of the light guide plate opposite from the light exit surface. The reflection member is configured to reflect light from the light guide plate with the reflection surface. The anisotropic light collecting portion is formed on a side of the light guide plate opposite from a side on which the reflection member is disposed. The anisotropic light collecting portion includes unit light collectors extending along a first direction that is along peripheral surfaces of the light guide plate not including the light entrance surface. The unit light collectors are arranged parallel to one another along a second direction along the peripheral surfaces including the light entrance surface. The anisotropic reflection portion includes unit reflectors that are disposed on the reflection surface of the reflection member. Each of the unit reflectors extends along the first direction. The unit reflectors are arranged parallel to one another along the second direction.

According to the configuration, rays of light emitted by the light source enter the light guide plate through the light entrance surface and travel through the light guide plate while reflected off the reflection surface of the light reflection member opposite from the light exit surface. Then, the rays of light exit from the light exit surface. Light collecting effects produced by the anisotropic light collecting portion formed on the side of the light guide plate opposite from the reflection member are less likely to affect the rays of light exiting from the light exit surface with respect to the first direction but affect the rays of light with respect to the second direction. The first direction is along the peripheral surfaces that are opposite from each other and do not include the light entrance surface among the peripheral surfaces of the light guide plate. The second direction is along the peripheral surfaces opposite from each other and including the light entrance surface among the peripheral surfaces of the light guide plate. Specifically, because the anisotropic light collecting portion includes the unit light collectors that extend along the first direction and arranged parallel to one another along the second direction, the light collecting effects selectively affect the rays of light with respect to the second direction that corresponds with the arrangement direction of the unit light collectors when the rays of light exiting from the unit light collectors.

The anisotropic reflection portion for reflecting rays of light from the plate surface of the light guide plate opposite from the light exit surface includes the unit reflectors. The unit reflectors extend along the first direction and arranged parallel to one another along the second direction. The rays of light from the light guide plate are reflected by the unit reflectors while angled with respect to the second direction that corresponds with the arrangement direction of the unit reflectors. Furthermore, the rays of light are reflected by the unit reflectors without angled with respect to the first direction that corresponds with the extending direction of the unit reflectors. Among the ray of light exiting from the light exit surface of the light guide plate and traveling toward the anisotropic light collecting portion, the rays of light traveling along the second direction that corresponds with the light collecting direction of the unit light collectors are angled by the anisotropic reflection portion. Therefore, a larger number of the rays of light which are more likely to exit without reflected back in directions from which they came are supplied to the anisotropic light collecting portion. According to the configuration, the light use efficiency improves and brightness of the light exiting from the anisotropic light collecting portion improves.

Preferable embodiments of the lighting device according to the present invention may include the following configurations.

(1) The unit light collectors of the anisotropic light collecting portion are unit prisms each having a triangular cross section. Because each of the unit light collectors of the anisotropic light collecting portion is a unit prism having a triangular cross section, levels of the light collecting effects that affect the exiting light can be adjusted according to the vertex of the unit prism.

(2) The lighting device may further include a lenticular lens portion on the light guide plate opposite the anisotropic light collecting portion. The lenticular lens portion may include cylindrical lenses that extend along the first direction and arranged parallel to one another along the second direction. According to the configuration, in the cylindrical lenses of the lenticular lens portion, the rays of light are totally reflected so as to travel along the first direction that corresponds with the extending direction of the cylindrical lenses and thus the rays of light are diffused with respect to the first direction. Furthermore, the light collecting effects selectively affect the rays of light with respect to the second direction that corresponds with the arrangement direction of the cylindrical lenses when the rays of light exit from the cylindrical lenses. The rays of light exiting from the lenticular lens portion are diffused with respect to the first direction and the light collecting effects affect the rays of light with respect to the second direction. The rays of light in such conditions enter the anisotropic light collecting portion. Namely, a larger number of the rays of light which are more likely to exit without reflected back in the directions from which they came are supplied to the unit light collectors of the anisotropic light collecting portion. According to the configuration, the light use efficiency further improves and the brightness of light exiting from the anisotropic light collecting portion further improves. Furthermore, uneven brightness is less likely to occur with respect to the first direction.

(3) The lenticular lens portion may be integrally formed with the light exit surface of the light guide plate. According to the configuration, the rays of light traveling inside the light guide plate are totally reflected by the cylindrical lenses before exiting from the light exit surface so as to travel along the first direction that corresponds with the extending direction of the cylindrical lenses. The rays of light are diffused with respect to the first direction and thus the uneven brightness is less likely to occur in the light exiting from the light exit surface. In comparison to a configuration in which the lenticular lens portion is prepared as a separate component from the light guide plate, the number of components is smaller. This configuration is preferable for reducing the cost.

(4) Each of the unit light collectors of the anisotropic light collecting portion may have a vertex angle set to 90°. A larger number of the rays of light are reflected back in the directions from which they came in comparison to a configuration in which each vertex angle is set to 90° or larger (obtuse). The exit angle range of the exiting light is further limited to a smaller range. According to the configuration, strong light collecting effects are achieved and the brightness further improves.

(5) Each of the unit reflectors of the anisotropic reflection portion may have a triangular cross section. Because each of the unit reflectors of the anisotropic reflection portion has the triangular cross section, angles at which the rays of light traveling along the second direction are reflected can be adjusted according to the vertex angle of the unit reflector.

(6) Each of the unit reflectors of the anisotropic reflection portion may have a vertex angle set in a range from 103° to 165°. In comparison to a configuration in which the vertex angle of each unit reflector is smaller than 103° or larger than 165°, the brightness of light exiting from the anisotropic light collecting portion improves.

(7) Each of the unit reflectors of the anisotropic reflection portion may have a vertex angle set in a range from 115° to 145°. According to the configuration, the brightness of light exiting from the anisotropic light collecting portion further improves. In comparison to a configuration that includes a reflection member including a flat reflection surface instead of the anisotropic reflection portion, the brightness of light exiting from the anisotropic light collecting portion improves by 2% or more.

(8) Each of the unit reflectors of the anisotropic reflection portion may have a vertex angle set in a range from 120° to 135°. According to the configuration, the brightness of light exiting from the anisotropic light collecting portion further improves. In comparison to the configuration that includes the reflection member including the flat reflection surface instead of the anisotropic reflection portion, the brightness of light exiting from the anisotropic light collecting portion improves by 3% or more.

(9) Each of the unit reflectors of the anisotropic reflection portion may have a vertex angle set to 130°. According to the configuration, the brightness of light exiting from the anisotropic light collecting portion further improves to a maximum level. In comparison to the configuration that includes the reflection member including the flat reflection surface instead of the anisotropic reflection portion, the brightness of light exiting from the anisotropic light collecting portion improves by 4% or more.

(10) Some of the unit reflectors of the anisotropic reflection portion may include rounded vertexes. According to the configuration, even if the vertexes of the unit reflectors of the anisotropic reflection portion are in contact with the plate surface of the light guide plate opposite from the light exit surface, the plate surface of the light guide plate is less likely to be scratched. Therefore, optical performances of the light guide plate and the unit reflectors are less likely to decrease.

(11) All of the unit reflectors of the anisotropic reflection portion may have rounded vertexes. According to the configuration, the plate surface of the light guide plate opposite from the light exit surface is further less likely to be scratched. Furthermore, the vertexes of the unit reflectors are further less likely to be deformed by the light guide plate. Therefore, the optical performances of the light guide plate and the unit reflectors are further less likely to decrease.

(12) The anisotropic reflection portion may include the unit reflectors that include the rounded vertexes and the unit reflectors that include the sharp vertexes, which are mixedly arranged. The unit reflectors that include the rounded vertex are arranged at intervals such that the unit reflectors that include the sharp vertexes therebetween with respect to the second direction. The vertexes of the unit reflectors that include the rounded vertexes are located closer to the light guide plate than those of the unit reflectors that include the sharp vertexes. Because the unit reflectors that include the rounded vertexes are arranged such that the vertexes thereof are located closer to the light guide plate than those of the unit reflectors that include the sharp vertexes, a clearance is provided between the unit reflectors that include the sharp vertexes and the plate surface of the light guide plate opposite from the light exit surface. According to the configuration, a contact area between the light guide plate and the anisotropic reflection portion decreases and thus they are less likely to be brought into close contact with each other. Furthermore, the unit reflectors that include the rounded vertexes are arranged at intervals such that the unit reflectors that include the sharp vertexes are therebetween with respect to the second direction. According to the configuration, positional relationships between the unit reflectors and the light guide plate remain stable.

Next, to solve the problem described earlier, a display device according to the present invention includes the above lighting device and a display panel configured to display images using light from the lighting device.

According to the display device having such a configuration, because light exiting from the lighting device has high brightness, high display quality is achieved.

The display panel may be a liquid crystal panel including liquid crystals sealed between boards. Such a display device may be used in various applications including liquid crystal displays for smartphones and tablet computers.

### Advantageous Effect of the Invention

According to the present invention, the brightness improves.

### BRIEF DESCRIPTION OF THE DRAWINGS

FIG. 1 is an exploded perspective view illustrating a general configuration of a liquid crystal display device according to a first embodiment of the present invention.

FIG. 2 is an exploded perspective view of illustrating a general configuration of a backlight unit in the liquid crystal device.

FIG. 3 is a cross-sectional view of the liquid crystal display device along a long-side direction thereof (a first direction, the X-axis direction) illustrating a cross-sectional configuration.

FIG. 4 is a cross-sectional view of the liquid crystal display device along a short-side direction thereof (a second direction, the Y-axis direction) illustrating a cross-sectional configuration.

FIG. 5 is a magnified cross-sectional view of an LED and therearound illustrated in FIG. 3.

FIG. 6 is a cross-sectional view of a backlight unit included in the liquid crystal display device along a short-side direction thereof (a second direction, the Y-axis direction) illustrating a cross-sectional configuration.

FIG. 7 is a table including pictures of a light guide plate taken from a light exit surface side and results of evaluation of uneven brightness for different tangent angles of cylindrical lenses of a lenticular lens portion.

FIG. 8 is a graph illustrating brightness angle distributions with respect to the second direction for different tangent angles of the cylindrical lenses of the lenticular lens portion.

FIG. 9 is a graph illustrating a relationship between an incidence angle of light to a prism sheet and an exit angle of light from the prism sheet.

FIG. 10 is a graph illustrating variations in brightness of light exiting from the prism sheet when a vertex angle of unit reflectors of an anisotropic reflection portion of a reflection sheet is varied in a range from 90° to 165° while a vertex angle of unit prisms of the prism sheet is fixe to 90° in comparative experiment 1.

FIG. 11 is a graph illustrating brightness angle distributions of the comparative sample and the sample with respect to the second direction in comparative experiment 2.

FIG. 12 is a graph illustrating brightness distributions of the comparative sample and the sample with respect to the first direction in comparative experiment 2.

FIG. 13 is a cross-sectional view of a backlight unit along a short-side direction thereof (a second direction, the Y-axis direction) illustrating a cross-sectional configuration according to a second embodiment of the present invention.

FIG. 14 is a table including relative brightness levels and full angles at half maximum of a comparative sample and samples 1 and 2 in comparative experiment 3.

FIG. 15 is a cross-sectional view of a backlight unit along a short-side direction thereof (a second direction, the Y-axis direction) illustrating a cross-sectional configuration according to a second embodiment of the present invention.

FIG. 16 is a table including relative brightness levels and full angles at half maximum of a comparative sample and samples 1 to 3 in comparative experiment 4.

FIG. 17 is a cross-sectional view of a backlight unit along a short-side direction thereof (a second direction, the Y-axis direction) illustrating a cross-sectional configuration according to a fourth embodiment of the present invention.

FIG. 18 is a cross-sectional view of a backlight unit along a short-side direction thereof (a second direction, the Y-axis direction) illustrating a cross-sectional configuration according to a fifth embodiment of the present invention.

### MODE FOR CARRYING OUT THE INVENTION

### First Embodiment

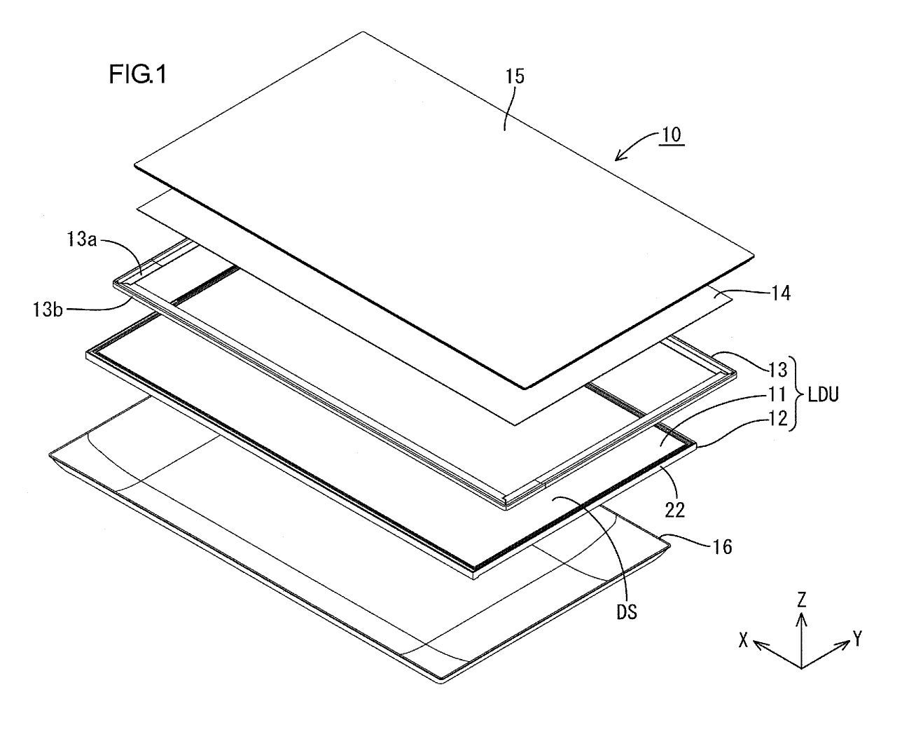

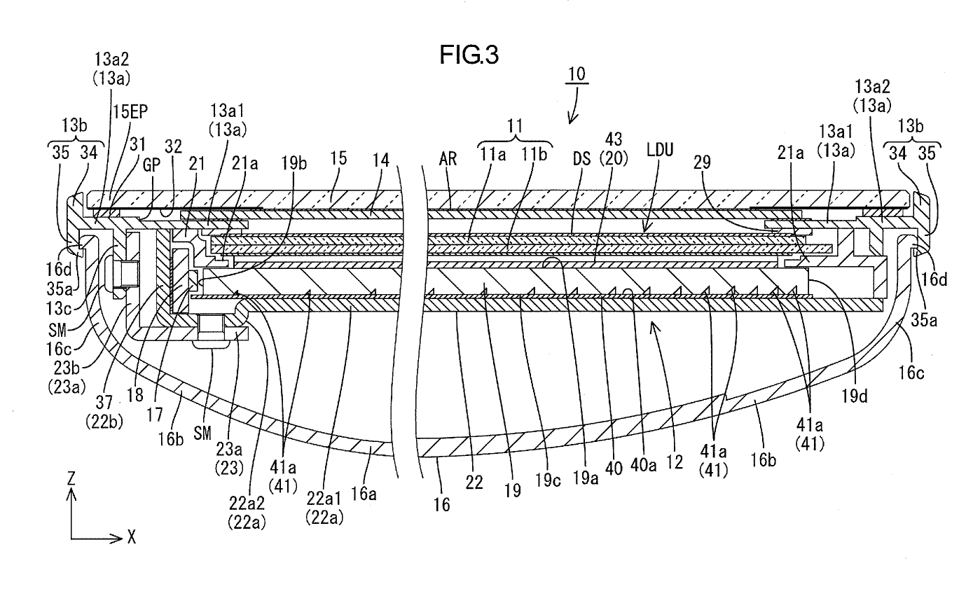

A first embodiment will be described with reference to FIGS. 1 to 12. In the following description, a liquid crystal display device 10 will be described. X-axes, Y-axes and Z-axes may be specified in the drawings. The axes in each drawing correspond to the respective axes in other drawings. The vertical direction is defined based on FIGS. 3 to 5 and the upper side and the lower side in those drawings correspond to the front and the rear of the device.

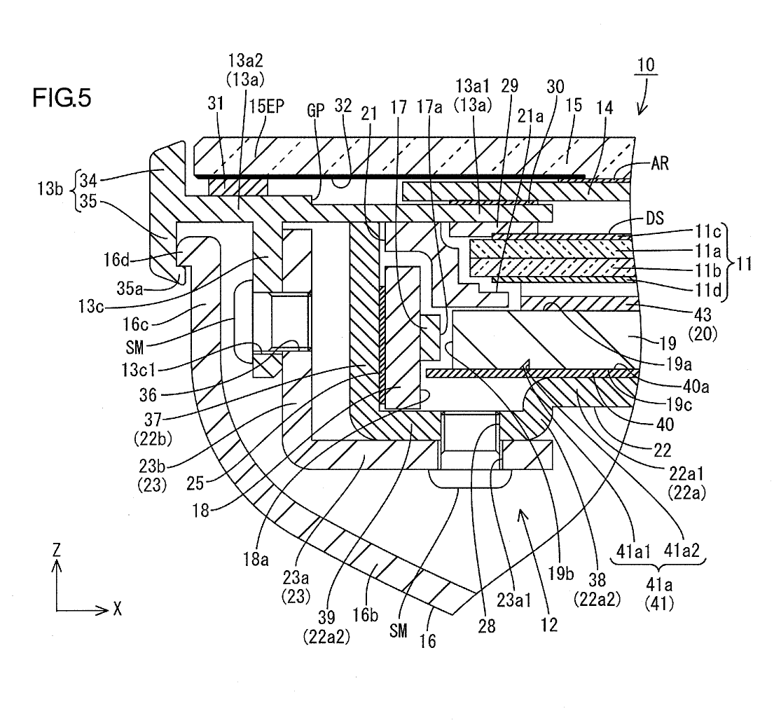

As illustrated in FIG. 1, the liquid crystal display device 10 has a rectangular overall shape in a plan view and includes a liquid crystal display unit LDU, which is a core component. The liquid crystal display device 10 includes a touchscreen 14, a cover panel (a protection panel, a cover glass) 15, and a case 16 fixed to the liquid crystal display unit LDU. The liquid crystal display unit LDU includes a liquid crystal panel (a display panel) 11, a backlight unit (a lighting device) 12, and a frame (a chassis component) 13. The liquid crystal panel 11 includes a display surface DS on the front side for displaying images. The backlight unit 12 is disposed behind the liquid crystal panel 11 and configured to emit light toward the liquid crystal panel 11. The frame 13 presses down the liquid crystal panel 11 from the front side, that is, a side opposite from the backlight unit 12 (a display surface DS side). The touchscreen 14 and the cover panel 15 are held in the frame 13 that is a component of the liquid crystal display unit LDU from the front and received by the frame 13 from the rear. The touchscreen 14 is disposed more to the front than the liquid crystal panel 11 with a predefined distance apart from the liquid crystal panel 11. A plate surface of the touchscreen 14 on the rear (or on the inner side) is an opposed surface that is opposed to the display surface DS. The cover panel 15 is disposed over the touchscreen 14 on the front and a plate surface thereof on the rear (or the inner side) is an opposed surface that is opposed to a plate surface of the touchscreen 14 on the front. An antireflective film AR is disposed between the touchscreen 14 and the color panel 15 (see FIG. 5). The case 16 is fixed to the frame 13 so as to cover the liquid crystal display unit LDU from the rear. Among the components of the liquid crystal display device 10, a portion of the frame 13 (a rolled portion 13b, which will be described later), the cover panel 15, and the case 16 form an appearance of the liquid crystal display device 10. The liquid crystal display device 10 according to this embodiment may be used for an electronic device such as a tablet computer, a screen size of which is about 20 inches.

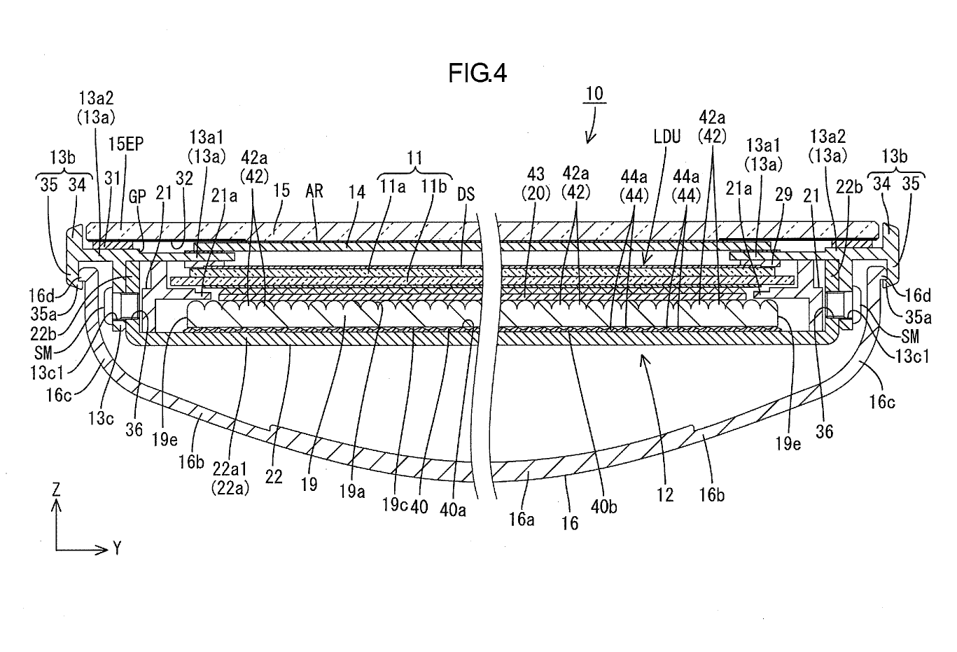

The liquid crystal panel 11 included in the liquid crystal display unit LDU will be described in detail. As illustrated in FIGS. 3 and 4, the liquid crystal panel 11 includes a pair of boards 11a and 11b and a liquid crystal layer (not illustrated). Each of the glass boards 11a and 11b is a substantially transparent glass board having a rectangular shape in a plan view and substantially transparent having high light transmissivity and high light transmissivity. The liquid crystal layer is between the boards 11a and 11b. The liquid crystal layer includes liquid crystal molecules that vary their optical characteristics according to application of electrical field. The boards 11a and 11b are bonded together with a sealant, which is not illustrated, while a predefined gap corresponding to a thickness of the liquid crystal layer is maintained therebetween. The liquid crystal panel 11 includes a display area (a middle area surrounded by a plate surface light blocking layer 32, which will be described later) and a non-display area (a peripheral area overlapping the plate surface light blocking layer 32, which will be described later). Images are displayed in the display area. The non-display area has a frame-like shape so as to surround the display area. Images are not displayed in the non-display area. A long-side direction, a short-side direction, and a thickness direction of the liquid crystal panel 11 correspond with the X-axis direction, the Y-axis direction, and the Z-axis direction, respectively.

One of the boards 11a and 11b on the front is a CF board 11a and one on the rear (on the back) is an array board 11b. On the inner surface of the array board 11b (on the liquid crystal layer side, a side opposed to the CF board 11a), a number of thin film transistors (TFTs) that are switching components and a number of pixel electrodes are disposed. Gate lines and source lines are routed in a grid so as to surround the TFTs and the pixel electrodes. Specific image signals are supplied from a control circuit, which is not illustrated, to the lines. Each pixel electrode surrounded by the gate lines and the source lines is a transparent electrode of indium tin oxide (ITO) or zinc oxide (ZnO).

On the CF board 11a, a number of color filters are disposed at positions corresponding to pixels. The color filters are arranged such that three colors of R, G and B are repeatedly arranged. Between the color filters, a light blocking layer (a black matrix) is formed for reducing color mixture. A counter electrode that is opposed to the pixel electrodes on the array board 11b is on surfaces of the color filters and the light blocking layer. The CF board 11a is slightly smaller than the array board 11b. On the inner surfaces of the boards 11a and 11b, alignment films for alignment of liquid crystal molecules in the liquid crystal layer are formed, respectively. On the outer surfaces of the boards 11a and 11b, polarizing plates 11c and 11d are bonded, respectively (see FIG. 5).

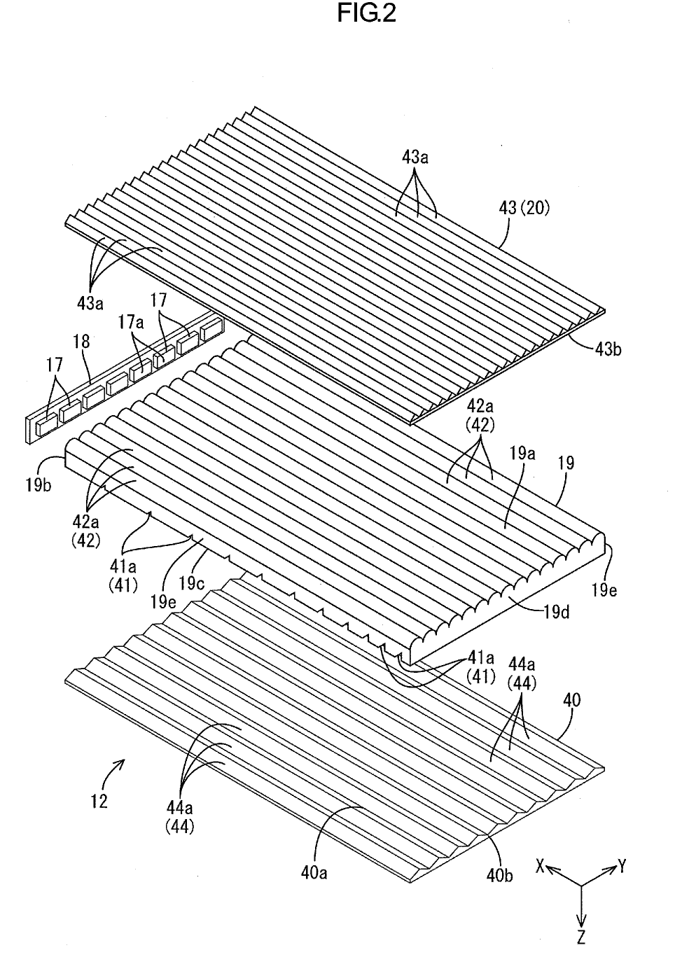

Next, the backlight unit 12 included in the liquid crystal display unit LDU will be described in detail. As illustrated in FIG. 1, the backlight unit 12 has a rectangular block-like overall shape in a plan view similar to the liquid crystal panel 11. As illustrated in FIGS. 2 to 4, the backlight unit 12 includes light emitting diodes (LEDs) 17, an LED board (a light source board) 18, a light guide plate 19, a reflection sheet (a reflection member) 40, an optical sheet (a anisotropic light collector, an optical member) 20, a light blocking frame 21, a chassis 22, and a heat dissipation member 23. The LEDs 17 are light sources. The LEDs 17 are mounted on the LED board 18. The light guide plate 19 guides light from the LEDs 17. The reflection sheet 40 reflects light from the light guide plate 19. The optical sheet is layered on the light guide plate 19. The light blocking frame 21 holds down the light guide plate 19 from the front. The chassis 22 holds the LED board 18, the light guide plate 19, the optical sheet 20, and the light blocking frame 21 therein. The heat dissipation member 23 is mounted so as to be in contact of the outer surface of the chassis 22. In the backlight unit 12, the LEDs 17 (the LED board 18) are disposed at one of the short sides of the periphery of the backlight unit 12. Namely, the backlight unit 12 is an edge-light type (a side-light type) which uses a method of supplying light from one side.

As illustrated in FIGS. 2, 3, and 5, each LED 17 includes an LED chip that is disposed on a board and sealed with a resin. The board is fixed to the LED board 18. Each LED chip mounted on the board has a main wavelength of emitting light is one kind. Specifically, the LED chip that emits light in a single color of blue is used. In the resin that seals the LED chip, phosphors that emit a certain color of light when excited by the blue light emitted by the LED chip are dispersed. An overall color of light emitted by the phosphors is substantially white. The phosphors may be selected from yellow phosphors that emit yellow light, green phosphors that emit green light, and red phosphors that emit red light and used in a combination. Alternatively, the phosphors in a single color may be used. A surface of each LED 17 is opposite from a mounting surface thereof that is mounted to the LED board 18 is a light emitting surface 17a, that is, the LED 17 is a top surface light emitting type.

As illustrated in FIGS. 2, 3, and 5, the LED board 18 has an elongated plate-like shape that extends in the Y-axis direction (the short-side direction of the light guide plate 19 or that of the chassis 22). The LED board 18 is held in the chassis 22 with the plate surface thereof parallel to the Y-Z plane, that is, perpendicular to the plate surface of the liquid crystal panel 11 or that of the light guide plate 19. Namely, the LED board 18 is held in a position such that the long-side direction and the short-side direction of the plate surface thereof correspond with the Y-axis direction and the Z-axis direction, respectively. Furthermore, the thickness direction thereof perpendicular to the plate surface corresponds with the X-axis direction. The LED board 18 is disposed such that a plate surface thereof facing the inner side (a mounting surface 18a) is opposite one of short peripheral surfaces of the light guide plate 19 with a predefined distance therefrom in the X-axis direction. An arrangement direction of the LEDs 17, the LED board 18, and the light guide plate 19 corresponds substantially with the X-axis direction. The LED board 18 has a length about equal to or larger than the short dimension of the light guide plate 19. The LED board 18 is mounted to the one of the short ends of the chassis 22, which will be described later.

As illustrated in FIG. 5, on the plate surface of the LED board 18 on the inner side, that is, the plate surface facing the light guide plate 19 (the surface opposed to the light guide plate 19), the LEDs 17 having the configuration described earlier are surface-mounted. The plate surface is the mounting surface 18a. The LEDs 17 are arranged in line (or linearly) on the mounting surface 18a of the LED board 18 at predefined intervals along the length direction thereof (the Y-axis direction). Namely, the LEDs 17 are arranged at intervals along the short-side direction of the backlight unit 12 at one of the short ends of the backlight unit 12. The intervals (or arrangement pitches) of the LEDs 17 are about equal. Furthermore, on the mounting surface 18a of the LED board 18, a trace (not illustrated) is formed from a metal film (e.g., a cupper film) for connecting the adjacent LEDs 17 in series. The trace extends along the Y-axis direction across the LEDs 17. When terminals formed at ends of the trace are connected to an external LED drive circuit, driving power is supplied to the LEDs 17. A base of the LED board 18 is made of metal similar to the chassis 22 and the trace (not illustrated) is formed on a surface of the base via an insulating layer. An insulating material such as ceramic may be used for the base of the LED board 18.

The light guide plate 19 is made of substantially transparent synthetic resin (e.g., acrylic resin such as PMMA) having a refractive index sufficiently larger than that of the air and high light transmissivity. As illustrated in FIG. 2, the light guide plate 19 has a substantially rectangular flat plate-like shape similar to the liquid crystal panel 11. The plate surface of the light guide plate 19 is parallel to the plate surface (or the display surface DS) of the liquid crystal panel 11. The long-side direction and the short-side direction of the light guide plate 19 correspond with the X-axis direction and the Y-axis direction, respectively. The thickness direction of the light guide plate 19 perpendicular to the plate surface corresponds with the Z-axis direction. As illustrated in FIGS. 3 and 4, the light guide plate 19 is disposed immediately below the liquid crystal panel 11 and the optical sheet 20 inside the chassis 22. One of the short peripheral surfaces of the light guide plate 19 is opposite the LEDs 17 on the LED board 18 at one of the short sides of the chassis 22. The arrangement direction of the LEDs 17 (or the LED board 18) and the light guide plate 19 corresponds with the X-axis direction. The arrangement direction of the optical sheet (or the liquid crystal panel 11) and the light guide plate 19 (or a direction in which they overlap) corresponds with the Z-axis direction. Namely, the arrangement directions are perpendicular to each other. The light guide plate 19 has a function of receiving rays of light emitted from the LEDs 17 to the light guide plate 19 along the X-axis direction (the arrangement direction of the LEDs 17 and the light guide plate 19) through the short peripheral surface, transmitting the rays of light therethrough, and guiding the rays of light toward the optical sheet 20 (toward the front or the light exiting side) so that the rays of light exit from the plate surface.

As illustrated in FIGS. 3 and 4, the plate surface of the light guide plate 19 having a flat plate-like shape facing the front (the surface opposed to the liquid crystal panel 11 or the optical sheet 20) is a light exit surface 19a through which the rays of light traveling therethrough exit toward the optical sheet 20 and the liquid crystal panel 11. One of short peripheries (on the left in FIG. 3) of the light guide plate 19 adjacent to the plate surface having an elongated shape along the Y-axis direction (the arrangement direction of the LEDs 17 or the long-side direction of the LED board 18) is opposed to the LEDs 17 (or the LED board 18) with a predefined gap therebetween as illustrated in FIG. 5. The short peripheral surface is configured as a light entrance surface through which the rays of light from the LEDs 17 enter and an LED opposed peripheral surface (a light source opposed peripheral surface) which is opposed to the LEDs 17. The light entrance surface 19b is parallel to the Y-Z plane and substantially perpendicular to the light exit surface 19a. The arrangement direction of the LEDs 17 and the light entrance surface 19b (or the light guide plate 19) corresponds with the X-axis direction and parallel to the light exit surface 19a. The other one of the short peripheral surfaces of the light guide plate 19 farther from the light entrance surface 19b described above (a peripheral surface opposite from the light entrance surface 19b) is referred to as an opposite peripheral surface 19d. Long peripheral surfaces adjacent to the light entrance surface 19b and the opposite peripheral surface 19d (the peripheral surfaces that are opposite from each other and do not include the light entrance surface 19b) are referred to as peripheral surfaces 19e. The peripheral surfaces 19e are surfaces parallel to the X-axis direction (the arrangement direction of the LEDs 17 and the light guide plate 19) and the Z-axis direction. The peripheral surfaces of the light guide plate 19 except for the light entrance surface 19b, that is, the opposite peripheral surface 19d and the peripheral surfaces 19e are LED non-opposed peripheral surfaces (light source non-opposed peripheral surfaces) which are not opposed to the LEDs 17 as illustrated in FIGS. 3 and 4. The rays of light emitted from the LEDs 17 and entering the light guide plate 19 through the light entrance surface 19b that is a peripheral surface of the light guide plate 19 may be reflected by the reflection sheet 40, which will be described later, or totally reflected by the light exit surface 19a, an opposite plate surface 19c, and other peripheries (the opposite peripheral surface 19d and the peripheral surfaces 19e) and thus efficiently transmitted through the light guide plate 19. If the light guide plate 19 is made of acrylic resin such as PMMA, the refractive index is about 1.49. Therefore, a critical angle may be about 42°. In the following description, a direction along the peripheral surfaces of the light guide plate 19 opposite from each other and do not include the light entrance surface 19b (the long peripheral surfaces, the peripheral surfaces 19e) (the X-axis direction) is referred to as a “first direction.” A direction along the peripheral surfaces opposite from each other and including the light entrance surface 19b (the short peripheral surfaces, the light entrance surface 19b and the opposite peripheral surface 19d) (the Y-axis direction) is referred to as a “second direction.”

As illustrated in FIGS. 3 and 4, among the plate surfaces of the light guide plate 19, the reflection sheet 40 is disposed on the opposite plate surface 19c that is opposite from the light exit surface 19a so as to cover an entire area of the opposite plate surface 19c. The reflection sheet 40 is configured to reflect the rays of light from the light guide plate 19 toward the front, that is, the light exit surface 19a. Namely, the reflection sheet 40 is sandwiched between a bottom plate 22a of the chassis 22 and the light guide plate 19. The reflection sheet 40 is opposed to the opposite plate surface 19c of the light guide plate 19. The reflection sheet 40 includes a reflection surface 40a for reflecting the rays of light. As illustrated in FIG. 5, an end portion of the refection sheet 40 closer to the light entrance surface 19b of the light guide plate 19 is outer than the light entrance surface 19b, that is extends toward the LEDs 17. The extending end portion reflects the rays of light from the LEDs 17. According to the configuration, light entering efficiency at the light entrance surface 19b improves. The reflection sheet 40 will be described in detail later. As illustrated in FIGS. 3 and 5, the opposite plate surface 19c of the light guide plate 19 includes a exiting light reflection portion 41 for reflecting the rays of light traveling through the light guide plate 19 such that the rays of light exit from the light exit surface 19a. The exiting light reflection portion 41 includes unit exiting light reflection grooves 41a each having a triangular cross-sectional shape (or a V-like cross-sectional shape) and extending along the second direction (the Y-axis direction). The unit exiting light reflection grooves 41a are arranged parallel to one another at intervals. Each unit exiting light reflection groove 41a includes a sloped surface 41a1 and a parallel surface 41a2. The sloped surface 41a1 is a surface sloped with respect to the thickness direction of the light guide plate 19, that is, a direction perpendicular to the first direction and the second direction (i.e., the Z-axis direction). The parallel surface 41a2 is a surface parallel to the thickness direction of the light guide plate 19. The rays of light are reflected by the sloped surface 41a1. According to the configuration, the incident angles of the rays of light to the light exit surface 19a do not exceed the critical angle and thus the rays of light are more likely to exit from the light exit surface 19a. Intervals of the unit exiting light reflection grooves 41a gradually decrease and areas of the sloped surfaces 41a1 and the parallel surfaces 41a2 increase as a distance from the LEDs 17 (or the light entrance surface 19b) in the first direction increases. According to the configuration, the rays of light exiting from the light exit surface 19a are controlled such that a uniform light distribution is achieved within the light exit surface 19a.

As illustrated in FIGS. 2 to 4, the optical sheet 20 has a rectangular shape in a plan view similar to the liquid crystal panel 11 and the chassis 22. The optical sheet 20 is disposed so as to cover the light exit surface 19a of the light guide plate 19 from the front (or the light exiting side). Because the optical sheet 20 is disposed between the liquid crystal panel 11 and the light guide plate 19, the rays of light exiting from the light guide plate 19 pass through the optical sheet 20. The optical sheet 20 directs the rays of light toward the liquid crystal panel 11 with specific optical properties added to the rays of light while passing therethrough. The optical sheet 20 will be described in detail later.

As illustrated in FIGS. 3 and 4, the light blocking frame 21 is formed in a frame-like (a picture frame-like) shape that extends along the periphery (or the peripheral surfaces) of the light guide plate 19. The light blocking frame 21 presses down the periphery of the light guide plate 19 for substantially the entire periphery. The light blocking frame 21 is made of synthetic resin. The light blocking frame 21 includes a surface in black, that is, has light blocking properties. The light blocking frame 21 is disposed such that an inner edge portion 21a thereof are arranged between the periphery of the light guide plate 19 and LEDs 17 and the periphery (or the peripheral surfaces) of the liquid crystal panel 11 and that of the optical sheet 20 for the entire periphery thereof. The light blocking frame 21 optically separate those from one another. According to the configuration, the rays of light from the LEDs 17 and not entering the light guide plate 19 through the light entrance surface 19b or the rays of light leaking through the opposite peripheral surface 19d or the peripheral surfaces 19e are blocked by the light blocking frame 21 and thus less likely to directly enter peripheries (especially the peripheral surfaces) of the liquid crystal panel 11 and the optical sheet 20. Each of three edge portions of the light blocking frame 21 not overlapping the LEDs 17 and the LED board 18 in a plan view (long edge portions and a short edge portion farther from the LED board 18) includes a portion projecting from the bottom plate 22a of the chassis 22 and a portion that supports the frame 13 from the rear. A short edge portion overlapping the LEDs 17 and the LED board 18 in a plan view is formed so as to cover the end of the light guide plate 19 and the LED board 18 (or the LEDs 17) from the front and bridge the long edge portions. The light blocking frame 21 is fixed to the chassis 22, which will be described next, with fixing members such as screws.

The chassis 22 is formed from a metal sheet having high thermal conductivity such as an aluminum sheet and an electrolytic zinc coated steel sheet (SECC). As illustrated in FIGS. 3 and 4, the chassis 22 includes the bottom plate 22a and side plates 22b. The bottom plate 22a has a rectangular shape similar to the liquid crystal panel 11 in a plan view. The side plates 22b project from outer edges (long edges and short edges) of the bottom plate 22a toward the front, respectively. A long-side direction and a short-side direction of the chassis 22 (or the bottom plate 22a) correspond with the X-axis direction and the Y-axis direction, respectively. A large portion of the bottom plate 22a is a light guide plate holding portion 22a1 for supporting the light guide plate 19 from the rear (an opposite side from the light exit surface 19a). An end portion of the bottom plate 22a closer to the LED board 18 is a board holding portion that protrudes toward the rear so as to form a step. As illustrated in FIG. 5, the board holding portion 22a2 has an L-like cross section. The board holding portion 22a2 includes a rising portion 38 and a holding bottom portion 39. The rising portion 38 bends from an end of the light guide plate holding portion 22a1 and rises toward the rear. The holding bottom portion 39 bends from a distal end of the rising portion 38 and projects toward a side opposite from the light guide plate holding portion 22a1. A position at which the rising portion 38 rises from the end of the light guide plate holding portion 22a1 is farther from the LEDs 17 than the light entrance surface 19b of the light guide plate 19 (closer to the middle of the light guide plate holding portion 22a1. The long side plate 22b bends and rises from the distal end of the holding bottom portion 39 toward the front. The LED board 18 is mounted to the short side plate 22b continues to the board holding portion 22a2. The short side plate 22b is a board mounting portion 37. The board mounting portion 37 includes an opposed surface that is opposed to the light entrance surface 19b of the light guide plate 19. The LED board 18 is mounted to the opposed surface. A plate surface of the LED board 18 opposite from the mounting surface 18a on which the LEDs 17 are mounted is fixed to an inner plate surface of the board mounting portion 37 with a board fixing member 25 such as a double-sided tape. The mounted LED board 18 is arranged with a small gap to the inner plate surface of the holding bottom portion 39 of the board holding portion 22a2. On the rear plate surface of the bottom plate 22a of the chassis 22, a liquid crystal panel drive circuit board (not illustrated) for controlling driving of the liquid crystal panel 11, an LED drive circuit board (not illustrated) for supplying driving power to the LEDs 17, and a touchscreen drive circuit board (not illustrated) for controlling driving of the touchscreen 14 are mounted.

The heat dissipation member 23 is formed from a metal sheet having high thermal conductivity such as an aluminum sheet. As illustrated in FIG. 3, the heat dissipation member 23 extends along the short edge of the chassis 22, specifically, the board holding portion 22a2 for holding the LED board 18. As illustrated in FIG. 5, the heat dissipation member 23 includes a first heat dissipation portion 23a and a second heat dissipation portion 23b. The first heat dissipation portion 23a has an L-like cross section. The first heat dissipation portion 23a is parallel to an outer surface of the board holding portion 22a2 and in contact with the outer surface. The second heat dissipation portion 23b is parallel to an outer surface of the side plate 22b that continues to the board holding portion 22a2 (or the board mounting portion 37). The first heat dissipation portion 23a has an elongated flat plate-like shape that extends along the Y-axis direction. A plate surface of the first heat dissipation portion 23a facing the front and parallel to the X-Y plane is in contact with the outer surface of the holding bottom portion 39 of the board holding portion 22a2 for about the entire length thereof. The first heat dissipation portion 23a is fixed to the holding bottom portion 39 with screws SM. The first heat dissipation portion 23a includes screw insertion holes 23a1 in which the screws SM are inserted. The holding bottom portion 39 includes screw holes 28 for the screws SM to be screwed. According to the configuration, heat from the LEDs 17 are transmitted to the first heat dissipation portion 23a via the LED board 18, the board mounting portion 37, and the board holding portion 22a2. The screws SM are arranged at intervals along the extending direction of the first heat dissipation portion 23a and fixed thereto. The second heat dissipation portion 23b has an elongated flat plate-like shape that extends along the Y-axis direction. A plate surface of the second heat dissipation portion 23b facing the inner side and parallel to the Y-Z plane is arranged opposite the outer plate surface with a predefined gap between the plate surface and the outer plate surface of the board mounting portion 37.

Next, the frame 13 included in the liquid crystal display unit LDU will be described. The frame 13 is made of metal having high thermal conductivity such as aluminum. As illustrated in FIG. 1, the frame 13 has a rectangular frame-like (a picture frame-like) overall shape along the peripheries (or the outer edge portions) of the liquid crystal panel 11, the touchscreen 14, and the cover panel 15 in a plan view. The frame 13 may be prepared by stamping. As illustrated in FIGS. 3 and 4, the frame 13 holds down the periphery of the liquid crystal panel 11 and holds the liquid crystal panel 11, the optical sheet 20, and the light guide plate 19, which are layered, together with the chassis 22 of the backlight unit 12. The frame 13 receives the peripheries of the touchscreen 14 and the cover panel 15 from the rear. The frame 13 is disposed between the peripheries of the liquid crystal panel 11 and the touchscreen 14. According to the configuration, a predefined gap is provided between the liquid crystal panel 11 and the touchscreen 14. Even if the touchscreen 14 is pushed by the cover panel 15 when an external force is applied to the cover panel 15 and deformed toward the liquid crystal panel 11, the deformed touchscreen 14 is less likely to affect the liquid crystal panel 11.

As illustrated in FIGS. 3 and 4, the frame 13 includes a frame portion (a frame base portion, a picture frame-like portion) 13a, a rolled portion (a tubular portion) 13b, and mounting plate portions 13c. The frame portions 13a are along the peripheries of the liquid crystal panel 11, the touchscreen 14, and the cover panel 15. The rolled portion 13b continues from the outer edge of the frame portion and surrounds the touchscreen 14, the cover panel 15, and the case 16 from the outer side. The mounting plate portions 13c project from the frame portion 13a toward the rear. The mounting plate portions 13c are mounted to the chassis 22 and the heat dissipation member 23. The frame portion 13a has a rectangular frame-like shape in a plan view including plate surfaces having flat plate-like shapes and parallel to the plate surfaces of the liquid crystal panel 11, the touchscreen 14, and the cover panel 15. An outer periphery 13a2 of the frame portion 13a has a thickness larger than that of an inner periphery 13a1 thereof. A gap GP is provided at a boundary between the inner periphery 13a1 and the outer periphery 13a2. The inner periphery 13a1 of the frame portion 13a is disposed between the periphery of the liquid crystal panel 11 and the periphery of the touchscreen 14. The outer periphery 13a2 receives the periphery of the cover panel 15 from the rear. Because the front plate surface of the frame portion 13a is covered with the cover panel 15 for about the entire area thereof, the front surface is less likely to be exposed to the outside. According to the configuration, even if a temperature of the frame 13 increases due to the heat from the LEDs 17, a user of the liquid crystal display device 10 is less likely to directly touch a portion of the frame 13 exposed to the outside. This configuration is advantageous in terms of safety. As illustrated in FIG. 5, a shock absorber 29 is fixed to the rear plate surface of the inner periphery 13a1 of the frame portion 13a. The shock absorber 29 is for pressing down the periphery of the liquid crystal panel 11 from the front and absorbing an impact that may be applied to the periphery of the liquid crystal panel 11. A first fixing member 30 is fixed to the front plate surface of the inner periphery 13a1 for fixing the periphery of the touchscreen 14 and absorbing an impact that may be applied to the periphery of the touchscreen 14. The shock absorber 29 and the first fixing member 30 are arranged at a position within the inner periphery 13a1 overlapping each other in a plan view. A second fixing member 31 is fixed to the front plate surface of the outer periphery 13a2 of the frame portion 13a for fixing the periphery of the cover panel 15 and absorbing an impact that may be applied to the periphery of the cover panel 15. The shock absorber 29 and the fixing members 30 and 31 are disposed so as to extend along the sides of the frame portion 13a except for four corners. The fixing members 30 and 31 may be double-side tapes that includes base materials having cushioning properties.

As illustrated in FIGS. 3 and 4, the rolled portion 13b includes a first rolled portion 34 and a second rolled portion 35. The first rolled portion 34 has a short rectangular tubular overall shape in a plan view and projects from an outer peripheral edge of the outer periphery 13a2 of the frame portion 13a toward the front. The second rolled portion 35 projects from the outer peripheral edge of the outer periphery 13a2 of the frame portion 13a toward the rear. Namely, the outer edge of the frame portion 13a continues to the inner surface of the rolled portion 13b having a short rectangular tubular shape at about the middle of the inner surface with respect the axial direction (the Z-axis direction) for the entire periphery of the rolled portion 13b. An inner periphery of the first rolled portion 34 is opposed to the peripheries of the touchscreen 14 and the cover panel 15. An outer periphery of the first rolled portion 34 is exposed to the outside of the liquid crystal display device 10, that is, forms appearances of sides of the liquid crystal display device 10. The second rolled portion 35 covers front edges (or mounting portions 16c) of the case 16 that is disposed behind the frame portion 13a from peripheral sides. An inner periphery of the second rolled portion 35 is opposed to the mounting portion 16c of the case 16, which will be described later. An outer periphery of the second rolled portion 35 is exposed to the outside of the liquid crystal display device 10, that is, forms appearances of sides of the liquid crystal display device 10. The second rolled portion includes a frame-side fixing portion 35a having a hook-like cross section at a distal end thereof. The case 16 is held to the frame-side fixing portion 35a to maintain the case 16 being fixed.

As illustrated in FIGS. 3 and 4, the mounting plate portions 13c project from the outer periphery 13a2 of the frame portion 13a toward the rear and has a plate-like shape that extends along the sides of the frame portion 13a. Plate surface of the mounting plate portions 13c are substantially perpendicular to the plate surface of the frame portion 13a. The mounting plate portions 13c are arranged at the respective sides of the frame portion 13a. The mounting plate portion 13c at the short side of the frame portion 13a on the LED board 18 side is mounted such that the inner plate surface thereof is in contact with the outer plate surface of the second heat dissipation portion 23b of the heat dissipation member 23. The mounting plate portions 13c are fixed to the second heat dissipation portion 23b with screws SM. The mounting plate portions 13c include screw insertion holes 13c1. The second heat dissipation portion 23b includes screw holes 36 for the screws SM to be fixed. Heat from the LEDs 17 transmitted from the first heat dissipation portion 23a to the second heat dissipation portion 23b is transmitted to the mounting plate portions 13c and then to the entire area of the frame 13. According to the configuration, the heat is efficiently dissipated. The mounting plate portion 13c is indirectly fixed to the chassis 22 via the heat dissipation member 23. The mounting plate portion 13c at the short side of the frame portion 13a farther from the LED board 18 and the mounting plate portions 13c at the long sides of the frame portion 13a are fixed with the screws SM such that the inner plate surface thereof is in contact with the outer plate surfaces of the side plates 22b of the chassis 22. The mounting plate portions 13c include screw insertion holes 13c1 in which the screws SM are inserted. The side plates 22b include screw holes 36 for the screws SM to be fixed. The screws SM are arranged along the extending direction of each mounting plate portion 13c at intervals and fixed to the mounting plate portions 13c.

Next, the touchscreen 14 fixed to the frame 13 the is described above will be described. As illustrated in FIGS. 1, 3 and 4, the touchscreen 14 is a position input device through which the user can input information regarding positions within the display surface DS of the liquid crystal panel 11. The touchscreen 14 has a rectangular shape. The touchscreen 14 includes a glass substrate that is substantially transparent and has high light transmissivity and a predefined touchscreen pattern (not illustrated) formed on the substrate. Specifically, the touchscreen 14 includes a glass substrate having a rectangular shape similar to the liquid crystal panel 11 in a plan view and a touchscreen transparent electrode (not illustrated) formed the front plate surface of the substrate. The touchscreen transparent electrodes are the touchscreen pattern using the projected capacitive touchscreen technology. A number of the touchscreen transparent electrodes are arranged in a grid within the plate surface of the substrate. Terminals (not illustrated) are formed in one of short edge portions of the touchscreen 14. The terminals are connected to traces continue from the touchscreen transparent electrodes that are portions of the touchscreen pattern. A flexible printed circuit board, which is not illustrated, is connected to the terminals. Electrical potentials are applied to the touchscreen transparent electrodes of the touchscreen pattern by a touchscreen drive circuit board. As illustrated in FIG. 5, the inner plate surface of the touchscreen 14 at the periphery thereof is fixed to the inner periphery 13a1 of the frame portion 13a of the frame 13 with the first fixing member 30 that is described earlier while they are opposed each other.

Next, the cover panel 15 mounted to the frame 13 will be described. As illustrated in FIGS. 1, 3 and 4, the cover panel 15 covers the entire area of the touchscreen 14 from the front to protect the touchscreen 14 and the liquid crystal panel 11. The cover panel 15 covers the entire area of the frame portion 13a of the frame 13 from the front and forms a front appearance of the liquid crystal display device 10. The cover panel 15 has a rectangular shape in a plan view. The cover panel 15 includes a base in a plate-like shape and made of transparent glass having high light transmissivity, preferably, toughened glass. Chemically toughened glass may be preferable for the tempered glass used for the cover panel 15. The chemically toughened glass includes a chemically toughened layer formed through a chemical toughening process on a surface of the glass base having a plate-like shape. The chemical toughening process may be a process for toughening a glass base having a plate-like shape by replacing alkali metal ions included in glass material with alkali metal ions each having a larger diameter by alkali metal ion exchange. The chemically toughened layer formed as above is a compressive stress layer (ion exchange layer) in which compression stress remains. Because the cover panel 15 has mechanical strength and high shock resistance, the cover panel 15 more properly protects the touchscreen 14 and the liquid crystal panel 11 disposed behind the cover panel 15 from break or damage.

As illustrated in FIGS. 3 and 4, the cover panel 15 has a rectangular shape similar to the liquid crystal panel 11 and the touchscreen 14 in a plan view. A size of the cover panel 15 in a plan view is slightly larger than those of the liquid crystal panel 11 and the touchscreen 14. The cover panel 15 includes a projecting portion 15EP that project outward over the peripheries of the liquid crystal panel 11 and the touchscreen 14 for the entire periphery, that is, the projecting portion 15EP has an eaves-like shape. The projecting portion 15EP has a rectangular frame-like shape (a picture frame-like shape) which surrounds the liquid crystal panel 11 and the touchscreen 14. As illustrated in FIG. 5, an inner plate surface of the projecting portion 15EP is fixed to the outer periphery 13a2 of the frame portion 13a of the frame 13 with the second fixing member 31 described earlier while they are opposed each other. A middle portion of the cover panel 15 opposite the touchscreen 14 is layered on the touchscreen 14 on the front via the antireflective film AR.

A illustrated in FIGS. 3 and 4, a plate surface light blocking layer (a light blocking layer, a plate surface light blocking portion) 32 is formed on an inner plate surface (or a rear plate surface, a plate surface opposed to the touchscreen 14) of the cover panel 15 that includes the projecting portion 15EP at the outer periphery. The plate surface light blocking layer 32 is made of light blocking material such as black paint. The plate surface light blocking layer 32 is formed by printing the light blocking material on the inner plate surface and thus integral with the plate surface. For forming the plate surface light blocking layer 32, printing including screen printing and inkjet printing may be used. The plate surface light blocking layer 32 is formed in the entire area of the projecting portion 15EP and an area that overlap the peripheries of the touchscreen and the liquid crystal panel 11 in a plan view. Namely, the plate surface light blocking layer 32 is formed so as to surround the display area of the liquid crystal panel 11. Therefore, rays of light outside the display area are blocked by the plate surface light blocking layer 32 and thus images are displayed in the display area with high display quality.

Next, the case 16 mounted to the frame 13 will be described. The case 16 is made of synthetic resin or metal. As illustrated in FIGS. 1, 3 and 4, the case 16 has a bowl-like shape with an opening on the front and covers the frame portion 13a and the mounting plate portions 13c of the frame 13, the chassis 22, and the heat dissipation member 23 from the rear and forms a rear appearance of the liquid crystal display device 10. The case 16 includes a bottom portion 16a, a curved portion 16b, and a mounting portion 16c. The bottom portion 16a is substantially flat. The curved portion 16b curves from a boundary of the bottom portion 16a toward the front and has a curved cross section. The mounting portion 16c projects from a boundary of the curved portion 16b substantially straight toward the front. The mounting portion 16c includes a case-side fixing portion 16d having a hook-like cross section. The case-side fixing portion 16d is hooked to the frame-side fixing portion 35d of the frame 13. According to the configuration, the case 16 is maintained fixed to the frame 13.

The backlight unit 12 in this embodiment has a configuration for collecting rays of light from the light exit surface 19a of the light guide plate 19 with respect to the second direction (the Y-axis direction). The configuration and a reason why it has such a configuration will be described. As illustrated in FIGS. 3 and 5, the rays of light traveling through the light guide plate 19 may be reflected off the sloped surfaces 41a1 of the unit exiting light reflection grooves 41a of the exiting light reflection portion 41 with angles. The incident angles of the rays of light to the light exit surface 19a are equal to or smaller than the critical angle and the rays of light exit from the light exit surface 19a. With respect to the first direction (the X-axis direction, the rays of light are reflected toward the front by the unit exiting light reflection grooves 41a, that is, the rays of light are collected so as to travel from the light exit surface 19a toward the front along the normal direction. The light collecting effects relative to the first direction affect the rays of light reflected by exiting light reflection portion 41 but the light collecting effects relative to the second direction are less likely to affect the rays of reflected light. This may cause anisotropy in brightness of light exiting from the light exit surface 19a. This embodiment has the following configuration to collect the rays of light with respect to the second direction. As illustrated in FIG. 2, the light exit surface 19a of the light guide plate 19 includes a lenticular lens portion 42. The lenticular lens portion 42 includes cylindrical lenses (a unit light collector) 42a extending in the first direction and arranged parallel to one another along the second direction. The optical sheet 20 includes a prism sheet (an anisotropic light collecting portion) 43 that includes unit prisms 43a. The unit prisms 43a that extend along the first direction are arranged parallel to one another along the second direction. Furthermore, the reflection sheet 40 includes an anisotropic reflection portion 44 that includes unit reflectors 44a. The unit reflectors 44a that extend in the first direction are arranged parallel to one another in the second direction. Next, the lenticular lens portion 42, the prism sheet 43, and the anisotropic reflection portion 44 will be described in detail.

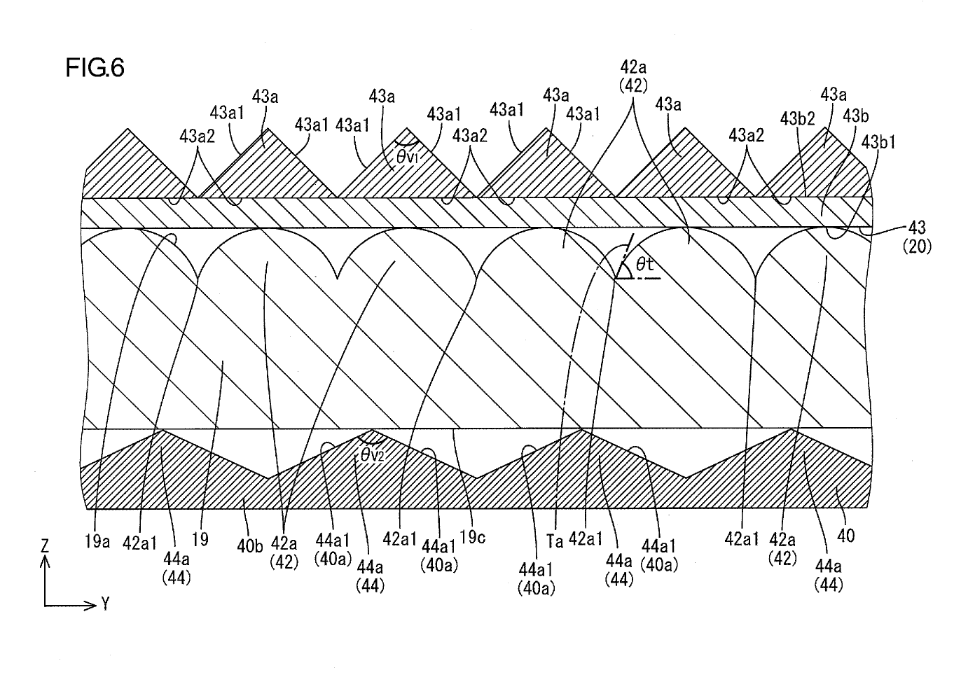

The lenticular lens portion 42 will be described. As illustrated in FIGS. 2 and 6, the lenticular lens portion 42 includes the cylindrical lenses 42a arranged along the second direction such that they extend in the first direction and the extending directions (or the length directions) thereof are parallel to one another in the light exit surface 19a of the light guide plate 19. Each cylindrical lens 42a has a half columnar shape. The lenticular lens portion 42 is integrally formed with the light guide plate 19. To form the lenticular lens portion 42 integrally with the light guide plate 19, the light guide plate 19 may be prepared by injection molding using a mold that has a forming surface in a shape of the lenticular lens portion 42 for transferring the shape. Each cylindrical lens 42a has a semicircular shape in a cross sectional view along the parallel direction (the second direction) perpendicular to the extending direction (the first direction). If rays of light inside the cylindrical lens 42a enter a curved outer surface (a boundary surface) at angles equal to or larger than the critical angle, the rays of light are totally reflected off the curved outer surface. The rays of light travel in the first direction inside the cylindrical lens 42a, that is, the rays of light are diffused in the first direction. Therefore, uneven brightness that may occur in the rays of light exiting from the light exit surface 19a is reduced. The effect of reduction of uneven brightness differs according to shapes of the cylindrical lenses 42a. Examples will be provided below.

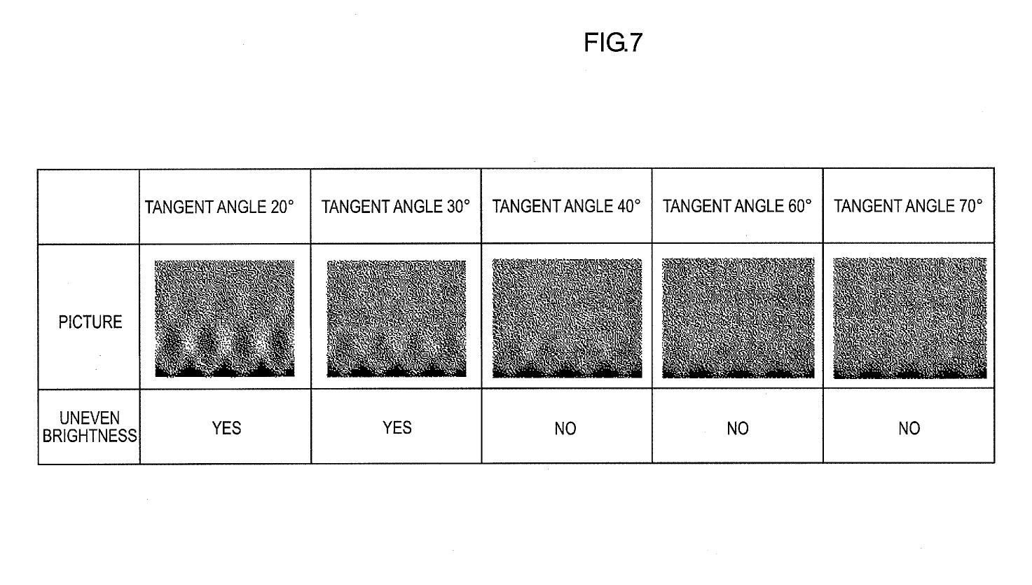

As illustrated in FIG. 6, an angle between a tangent line Ta at a base end portion 42a1 of the curved outer surface of each cylindrical lens 42a and the second direction is defined as “tangent angle θt.” The light guide plates 19 including the lenticular lens portions 42 that include the cylindrical lenses 42a with tangent angles θt set to 20°, 30°, 40°, 60°, and 70° were prepared and experiments were performed. In the experiments, the LEDs 17 were turned on and pictures of the light exit surfaces 19a were taken while the rays of light were exiting from the light guide plates 19. Whether uneven brightness were observed or not were determined based on the pictures. The results of the experiments are shown in FIG. 7. FIG. 7 illustrates the results of the determination of uneven brightness based on the pictures of the light exit surface 19a while the rays of light were exiting from the light guide plates 19 with tangent angles θt set to 20°, 30°, 40°, 60°, and 70°. According to FIG. 7, the smaller the tangent angles θt, the larger the difference in brightness at a position immediately above the LEDs 17 and at a position between the LEDs 17. Namely, the uneven brightness is more likely to be observed. The larger the tangent angles θt, the smaller the difference in brightness at the position immediately above the LEDs 17 and at the position between the LEDs 17. Namely, the uneven brightness is less likely to be observed. It was determined that “uneven brightness was observed” in the ones with tangent angles et set to 20° and 30°. It was determined that “uneven brightness was not observed” in the ones with tangent angles θt set to 40°, 60°, and 70°. In terms of reduction of uneven brightness, it is preferable to set tangent angle θt of each cylindrical lens 42a equal to or larger than the 40°. Tangent angle θt of each cylindrical lens 42a in the lenticular lens potion 42 of this embodiment is set equal to or larger than 40° (e.g., 70°).

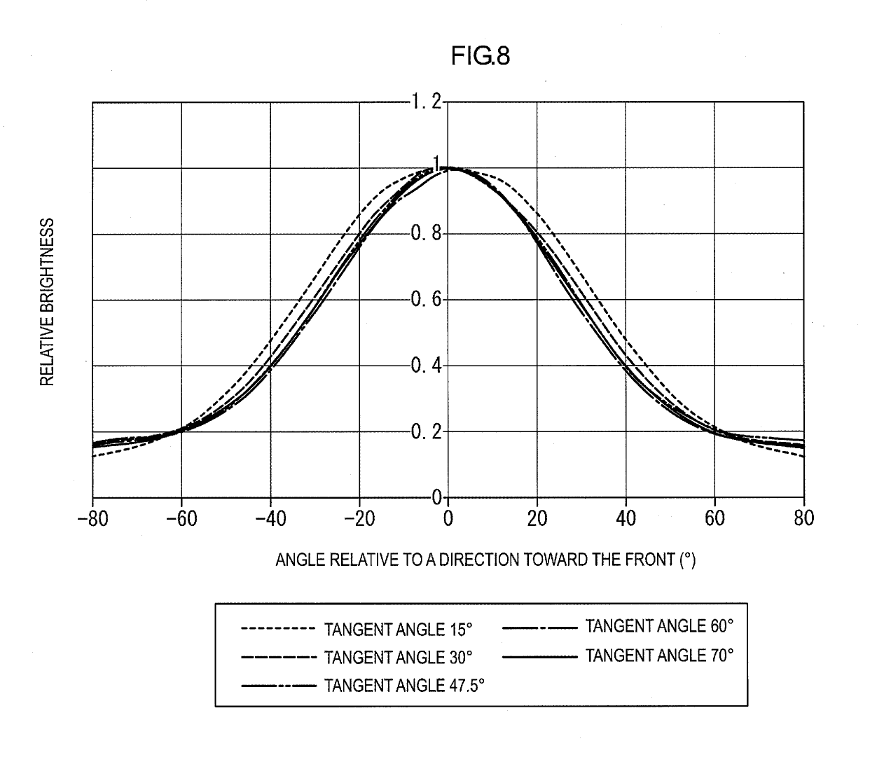

As illustrated in FIG. 6, when the rays of light in each cylindrical lens 42a enter the curved outer surface at angles equal to or smaller than the critical angle, the rays of light refract off the outer surface and exit. Light collecting effects relative to the second direction selectively affect the rays of light. The second direction corresponds with the light collecting direction of the cylindrical lens 42a. The rays of light that pass a focal point of the cylindrical lens 42a may refract off the curved outer surface and exit as rays parallel to a direction toward the front. Among the rays of light exiting from the light exit surface 19a, the rays of light traveling in the second direction are selectively directed toward the front. Such light collecting effects are achieved. The light collecting effects are less likely to change according to the shapes of the cylindrical lenses 42a. The light guide plates 19 including the lenticular lens portions 42 that include the cylindrical lenses 42a with tangent angles θt set to 15°, 30°, 47.5°, 60°, and 70° were prepared and experiments were performed. In the experiments, brightness levels of the light exiting from the light guide plates 19 were measured. The results of the experiments are shown in FIG. 8. A graph in FIG. 8 illustrates brightness angle distributions of light from each light guide plate 19 with respect to the second direction. In FIG. 8, the vertical axis represents relative brightness of light exiting from the light guide plates (without unit) and the horizontal axis represents angles with respect to the direction toward the front (in unit of degrees (°)). In FIG. 8, the relative brightness represented by the vertical axis is expressed in relative values when the brightness in the direction toward the front (at an angle of 0°) is defined as a reference (1.0). According to FIG. 8, the brightness angle distribution at tangent angle θt of 15° is the gentlest. However, the brightness angle distributions at other tangent angles θt are about the same regardless of the tangent angles. Namely, according to the configuration in which the light exit surface 19a of the light guide plate 19 includes the lenticular lens portion 42, light collecting effects at a certain level or higher can be achieved regardless of the shape (or the tangent angle θt) of the cylindrical lens 42a.

Next, the prism sheet 43 of the optical sheet 20 will be described. As illustrated in FIGS. 2 and 6, the prism sheet 43 includes a base 43b and the unit prisms 43a. The base 43b has a sheet-like shape. The unit prisms 43a are formed on a light exit-side plate surface 43b2 that is opposite from the light entrance-side plate surface 43b1 through which rays of light from the light guide plate 19 enter (i.e., the light exit side). The unit prisms 43a have anisotropic light collection properties. The base 43b is made of substantially transparent synthetic resin, for example, thermoplastic resin such as PET. The base 43b has the refractive index of about 1.667. The unit prisms 43a are formed on the light exit-side plate surface 43b2 that is the front plate surface of the base 43b. The unit prisms 43a are made of substantially transparent ultraviolet curing resin that is one kind of light curing resins. To prepare the prism sheet 43, a forming die is filled with the ultraviolet curing resin that is not cured and the base 43b is placed against edge of a hole of the forming die such that the ultraviolet curing resin that is not cured is placed against the light exit-side plate surface 43b2. Then, ultraviolet rays are applied to the ultraviolet curing resin via the base 43b to harden the ultraviolet curing resin. As a result, the unit prisms 43a are formed integrally with the base 43b. The ultraviolet curing resin of the unit prisms 43a may be acrylic resin such as PMMA having a refractive index of about 1.59. Each unit prism 43a protrudes along the Z-axis direction from the light exit-side plate surface 43b2 of the base 43b toward the front (a side opposite from the light guide plate 19). The unit prism 43a has a triangular (a peaked shape) cross section along the second direction (the Y-axis direction) and linearly extends along the direction (the X-axis direction). The unit prisms 43a are arranged along the second direction on the light exit-side plate surface 43b2. Each unit prism 43a has an isosceles triangular cross section and includes a pair of sloped surfaces 43a1 with a vertex angle θV1 of an about right angle (90°). The vertex angles θV1, widths of the bottom surfaces 43a2, and heights of the unit prisms 43a arranged parallel to one another along the second direction are about equal to one another, respectively. Furthermore, intervals of the unit prisms 43a are about equal.

When rays of light from the light guide plate 19 enter the prism sheet 43 having the configuration that is described above, the ray of light travel from an air layer between the lenticular lens portion 42 (or the cylindrical lenses 42a) of the light guide plate 19 and the base 43b of the prism sheet 43 to the light entrance-side plate surface 43b1 of the base 43b and enter the light entrance-side plate surface 43b1 as illustrated in FIG. 6. The lays of light are refracted at the boundary according to incident angles. When the rays of light that pass through the base 43b and travel from the light exit-side plate surface 43b2 of the base 43b enter the unit prisms 43a, the rays of light are refracted at the boundary according to incident angles. When the rays of light that pass through the unit prisms 43a reach the slope surfaces 43a1 of the unit prisms 43a, if the incident angles are larger than the critical angle, the rays of light are fully reflected and returned to the base 43b (retroreflection). If the incident angles are not larger than the critical angle, the rays of light are refracted at the boundary and exit. The rays of light exiting from the sloped surfaces 43a1 of the unit prisms 43a and traveling toward the adjacent unit prisms 43a enter the unit prisms 43a and return to the base 43b. According to the configuration, traveling directions of the rays of light from the unit prisms 43a with respect to the second direction are controlled so as to be closer to the direction toward the front, that is, the light collecting effects relative to the second direction selectively affect the rays of light.

Next, the reflection sheet 40 will be described. As illustrated in FIG. 6, the reflection sheet 40 includes a reflection base 40b and an isotropic reflection portion 44. The reflection base 40b has a sheet-like shape and includes reflection surfaces 40a that are located on the front and opposed to the light guide plate 19. The isotropic reflection portion 44 is formed on the reflection surface 40a of the reflection base 40b and has anisotropic light reflection properties. The reflection sheet 40 is made of synthetic resin. The reflection base 40b and the anisotropic reflection portion 44 are made of the same material and integrally formed. The reflection sheet 40 includes white surfaces having high light reflectivity. To integrally form the anisotropic reflection portion 44 with the reflection base 40b, the reflection sheet 40 may be prepared by injection molding using a forming die that has a forming surface in a shape of the anisotropic reflection portion 44 for transferring the shape. The anisotropic reflection portion 44 includes unit reflectors 44a each having a triangular (a peaked shape) cross section along the second direction (the Y-axis direction) and linearly extends along the first direction (the X-axis direction). The unit reflectors 44a are arranged parallel to one another along the second direction on the reflection surface 40a of the reflection base 40b. Each unit reflector 44a has an isosceles triangular cross section and includes a pair of sloped surfaces 44a1 with an obtuse vertex angle θv2, specifically, about 130°. Namely, the vertex angle θv2 of each unit reflector 44a is larger than the vertex angle θv1 of the unit prism 43a of the prism sheet 43. Each unit reflector 44a has a symmetric shape. The vertex angles θv2, widths of bottom surfaces, and heights of the unit reflectors 44a are arranged parallel to one another along the second direction are about equal to one another, respectively. Intervals of the unit reflectors are about equal. The unit reflectors 44a have the widths and the intervals about 0.01 mm.

Rays of light exiting from the opposite plate surface 19c of the light guide plate 19 travel toward the reflection sheet 40 having the configuration described above. As illustrated in FIG. 6, the rays of light are reflected off the sloped surfaces 44a1 of the unit reflectors 44a of the anisotropic reflection portion 44. Rays of the reflected light are angled to the second direction (the Y-axis direction) according to the vertex angle θv2 but not angled to the second direction. The rays of the reflected light angled to the second direction exit from an air layer between the sloped surface 44a1 of each unit reflector 44a and the opposite plate surface 19c of the light guide plate 19 and enter the light guide plate 19 through the opposite plate surface 19c. The rays of the reflected light are refracted at the opposite plate surface 19c when reenter the light guide plate 19. The exiting light reflection portion 41 is formed on the opposite plate surface 19c as described earlier. Therefore, the rays of light reflected by the reflection sheet 40 may enter the light guide plate 19 through the unit exiting light reflection grooves 41a of the exiting light reflection portion 41. After reaching the lenticular lens portion 42 on the light exit surface 19a, the ray of light which have entered the light guide plate 19 may exit while the light collecting effects selectively affect the rays of light with respect to the second direction or may be totally reflected and return to the reflection sheet 40. The rays of light exiting from the cylindrical lenses 42a of the lenticular lens portion 42 enter the prism sheet 43 and exit while the light collecting effects produced by the unit prisms 43a selectively affect the rays of light with respect to the second direction. With the anisotropic reflection portion 43 of the reflection sheet 40, the rays of light from the lenticular lens portion 42 toward the prism sheet 43 are selectively angled with respect to the second direction such that a larger number of the rays of light exit without reflected back in directions from which they came. Therefore, the brightness of the light exiting from the prism sheet 43 improves.

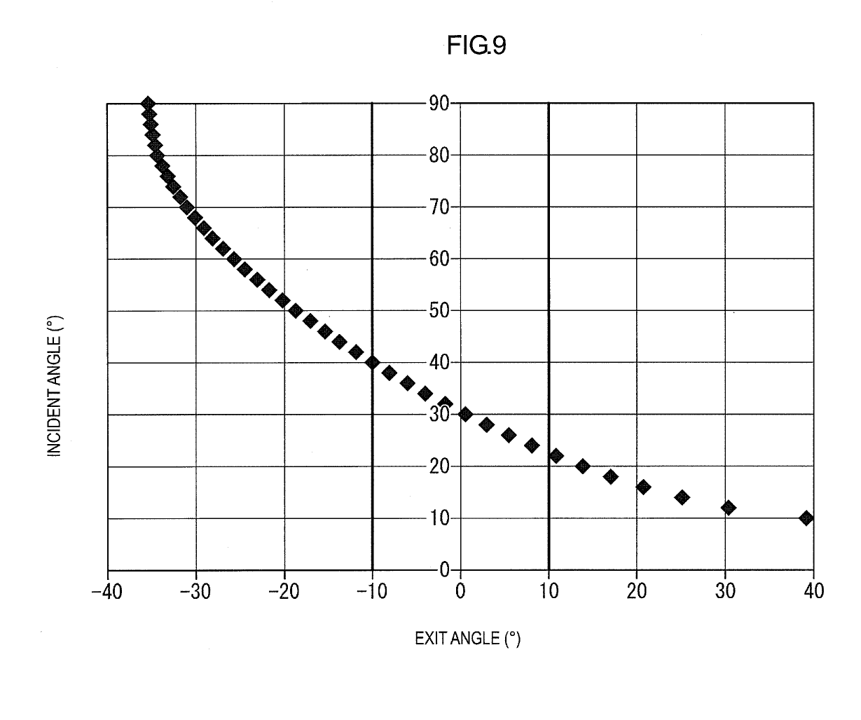

The following verification was performed to find out at what angles that rays of light exiting from the prism sheet 43 contribute to improvement of forward brightness of light exiting from the prism sheet 43. A relationship between an incident angle of the ray of light entering the light entrance-side plate surface 43b1 of the prism sheet 43 and an exit angle of the ray of light exiting from the sloped surface 43a1 of the unit prism 43a was calculated by Snell's law. The results are illustrated in FIG. 9. The exit angle of the ray of light from the light entrance-side plate surface 43b1 was calculated based on the incident angle of the ray of light to the light entrance-side plate surface 43b1. The incident angle of the ray of light from the light entrance-side plate surface 43b1 is equal to the incident angle of the ray of light to the light exit-side plate surface 43b2 and to the bottom surface 43a2 of the unit prism 43a. Therefore, an angle of the ray of light exiting from the light exit-side and an angle of the ray of light exiting from the bottom surface 43a2 of the unit prism 43a were calculated. The exit angles of rays of light from the light exit-side plate surface 43b2 and the bottom surface 43a2 of the unit prism 43a are equal to the incident angle of ray of light entering the sloped surface of the unit prism 43a. Therefore, an exit angle of ray of light from the sloped surface 43a1 of the unit prism was calculated. The refractive indexes of the base 43b and the unit prism 43a and the vertex angle θv1 of the unit prism 43a are as described earlier and the refractive index of the air layer is “1.0.” In FIG. 9, the vertical axis represents an incident angle of ray of light to the light entrance-side plate surface 43b1 of the base 43b (in degree (°)) and the horizontal axis represents an exit angle of ray of light exiting from the sloped surface 43a1 of the unit prism 43a (in degree (°)). The exit angle of 0° is an angle parallel to the direction toward the front. According to FIG. 9, if the exit angle of ray of light from the sloped surface 43a1 of the unit prism 43a needs to be set in a range ±10°, the incident angle of ray of light to the light entrance-side plate surface 43b1 of the base 43b needs to be set in a range from 23° to 40°. Namely, if the exit angle is set in the range from 23° to 40°, the ray of light to the prism sheet 43, that is, the ray of light exiting from the lenticular lens portion 42 of the light guide plate 19, the ray of light exits from the unit prism 43a of the prism sheet 43 at an angle within ±10° relative to the direction toward the front. This configuration is advantageous for improving the forward brightness of the exiting light. Next, comparative experiments were conducted to find out how the forward brightness of the prism sheet 43 varies when the vertex angle θv2 of the unit reflectors 44a was altered.

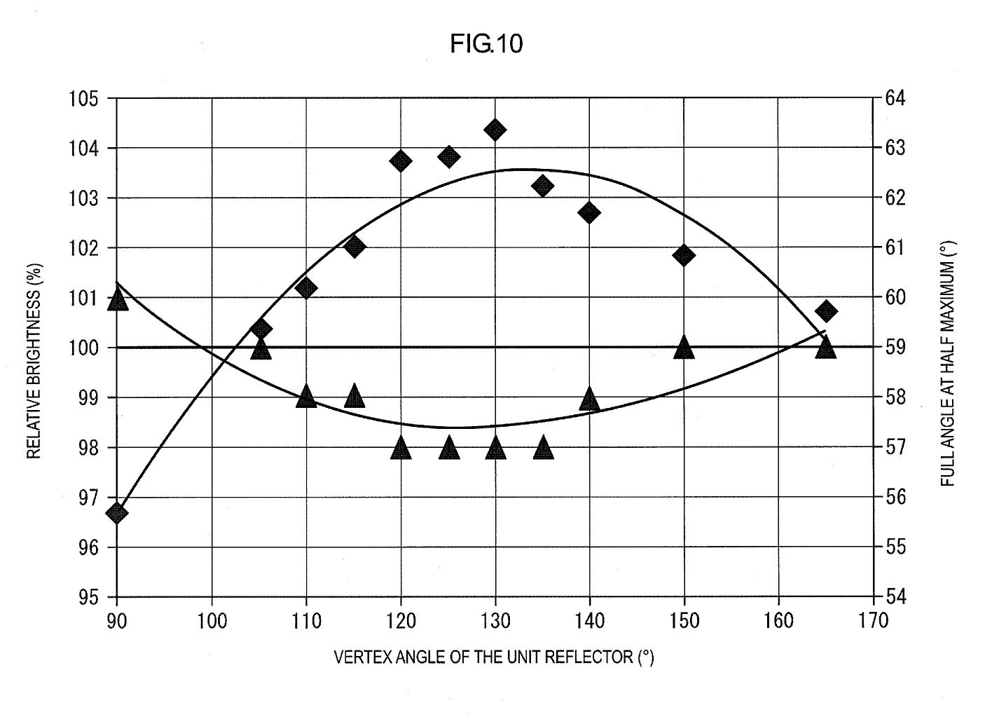

Comparative experiment 1 will be described. In comparative experiment 1, the vertex angle θv2 of each unit reflector 44a of the anisotropic reflection portion 44 of the reflection sheet 40 was varied within a range from 90° to 165° while the vertex angle θv1 of each unit prism 43a of the prism sheet 43 was fixed to 90°. The brightness levels of light exiting from the prism sheet 43 were measured and the results were illustrated in FIG. 10. In comparative experiment 1, the reflection sheets 40 that includes the unit reflectors 44a with thevertexangles θv2 set to 90°, 105°, 110°, 115°, 120°, 125°, 130°, 135°, 140°, 150°, and 165°, respectively, were prepared. For each reflection sheet 40, the light guide plate 19 that includes the lenticular lens portion 42 was disposed in front and the prism sheet 43 that includes the unit prisms 43a each having the vertex angle θv1 set to 90° was disposed in front of the light guide plate 19. The LEDs 17 were turned on and the brightness levels of light exiting from the prism sheet 43 were measured. In FIG. 10, the vertical axis on the left represents relative brightness of light exiting from the prism sheet 43 (in percent (%)), the vertical axis on the right represents full angles at half maximum of light exiting from the prism sheet 43 (in degree (°)), and the horizontal axis represents the vertex angle of the unit reflectors 44a of the anisotropic reflection portion 44 (in degrees (°)). In FIG. 10, diamond marks represent relative brightness levels and triangular marks represent full angles at half maximum. In FIG. 10, the relative brightness is expressed in relative values defined based on a reference (100%) which corresponds to a brightness level measured in a configuration that includes a reflection sheet having a flat shape without the anisotropic reflection portion 44. The full angles at half maximum represented by the vertical axis in FIG. 10 correspond to an angle range in which the brightness of the exiting light is equal to half of the maximum level of the brightness (a brightness level relative to the maximum brightness level is 0.5). Regarding the full angle at half maximum, a value measured when a reflection sheet that includes a flat reflection surface was used is 59°, and this value is defined as a reference. If the results of comparative experiment 1 are smaller than the reference, a larger number of the rays of exiting light are collected to the direction toward the front, that is, the forward brightness is higher. If the results of comparative experiment 1 are larger than the reference, a larger number of the rays of exiting light are off the direction toward the front, that is, the forward brightness is lower. The relative brightness and the full angle at half maximum represented by the vertical axes in FIG. 10 are substantially inversely correlated with each other. The reflection sheet 40 that includes the unit reflectors 44a each having the vertex angle set to 90° is a comparative sample.

The results of comparative experiment 1 will be described. According to a graph in FIG. 10, when the vertex angle θv2 of each unit prism 43a is set to 90° and the vertex angle θv2 of each unit reflector 44a is set within a range from 103° to 165° (a difference between the vertex angle θv1 of each unit prism 43a and the vertex angle θv2 of each unit reflector 44a is within a range from 13° to 75°), the brightness of light exiting from the prism sheet 43 improves in comparison to the configuration that includes the reflection sheet having the flat reflection surface. Furthermore, the full angle at half maximum decreases and the forward brightness improves. Specifically, if the vertex angle θv2 of the unit reflectors 44a is set to 90°, that is, smaller than 103°, the brightness of exiting light is lower and the full angle at half maximum is larger in comparison to the configuration that includes the reflection sheet having the flat reflection surface. Namely, the forward brightness decreases and thus the reflection sheet 40 that includes the anisotropic reflection portion 44 is ineffective. If the vertex angle θv2 of the unit reflectors 44a is larger than 165°, the brightness of the exiting light becomes lower than the reference, that is, 100% and the full angle at half maximum becomes larger than the reference, that is, 59°. In comparison to the configuration that includes the reflection sheet having the flat reflection surface, the forward brightness of the exiting light may decrease. This may be because the light exiting from the unit reflectors 44a includes a larger number of rays with exit angles in a range from 23° to 40° when the vertex angle θv2 of the unit reflectors is set in the range from 103° to 165° in comparison to the configuration that includes the reflection sheet having the flat reflection surface. Next, the results will be further examined to fine out a more preferable range of the vertex angle θv2 of the unit reflectors 44a. If the vertex angle θv2 is in a range from 115° to 145° (the difference between the vertex angle θv1 of the unit prism 43a and the vertex angle θv2 of the unit reflector 44a is in a range from 25° to 55°), the brightness of exiting light improves by 2% or more and the full angle at half maximum decreases by 1% or more in comparison to the configuration that includes the reflection sheet having the flat reflection surface. If the vertex angle θv2 of the unit reflectors 44a is set in a range from 120° to 135° (the difference between the vertex angle θv1 of the unit prisms 43a and the vertex angle θv2 of the unit reflectors 44a is in a range from 30° to) 45°, the brightness of exiting light improves by 3% or more and the full angle at half maximum decreases by 2% or more in comparison to the configuration that includes the reflection sheet having the flat reflection surface. This configuration is more preferable. If the vertex angle θv2 of the unit reflectors is set to 130° (the difference between the vertex angle θv1 of the unit prisms 43a and the vertex angle θv2 of the unit reflectors 44a is 40°), the brightness of exiting light improves by 4% or more and the full angle at half maximum decreases about 2% in comparison to the configuration that includes the reflection sheet having the flat reflection surface. The maximum level of the forward brightness is achieved. This configuration is the most preferable.

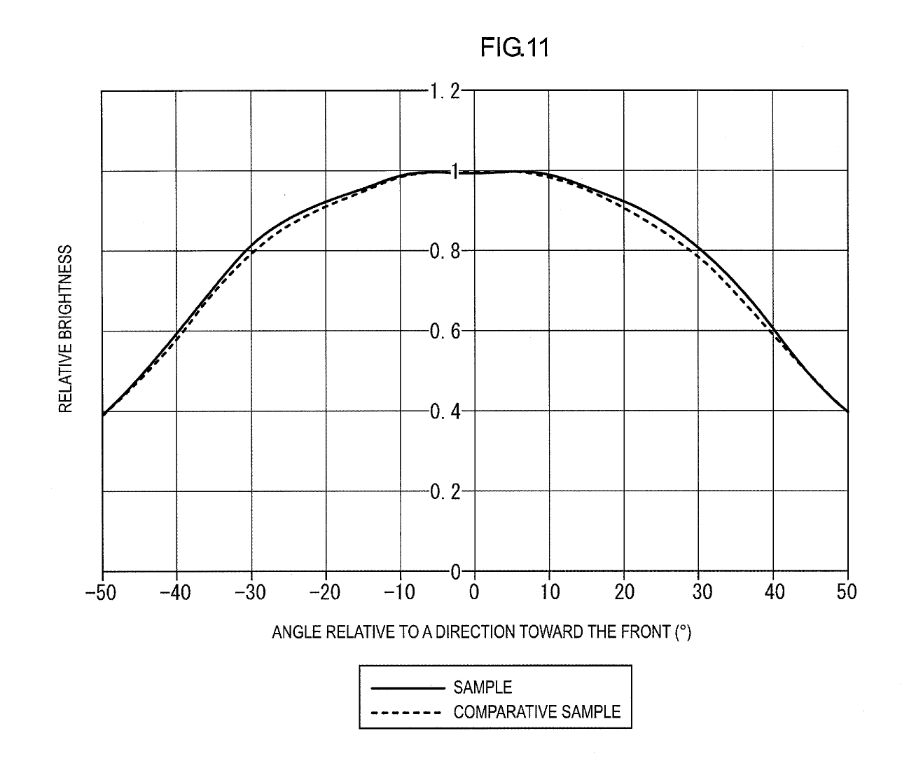

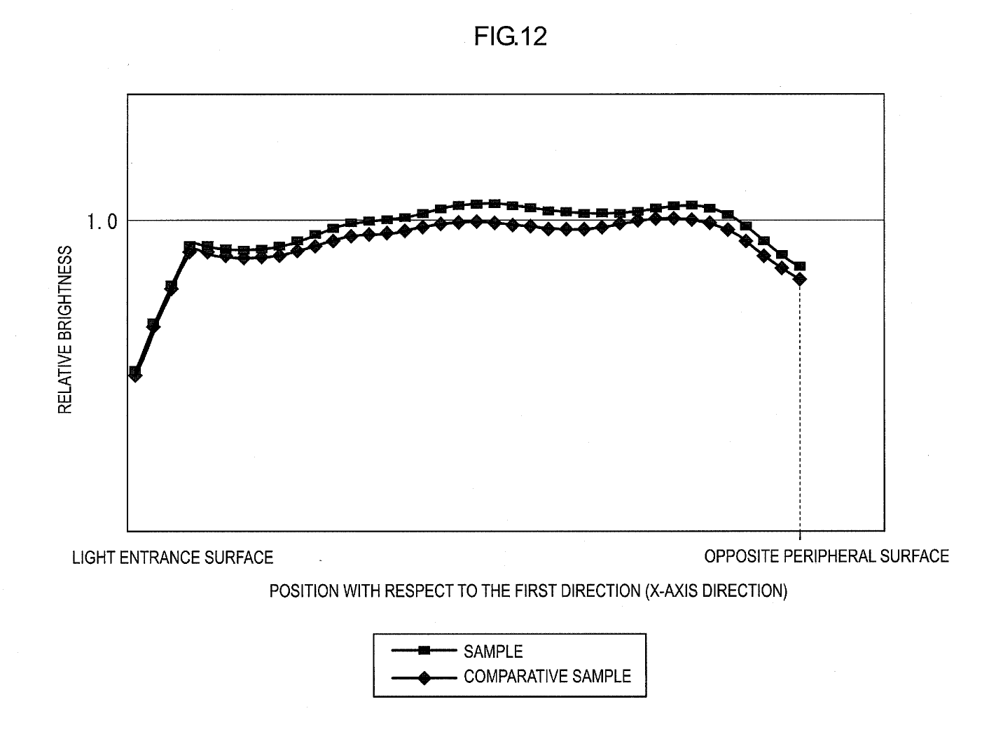

For further examination of the results of comparative experiment 1, comparative experiment 2 were conducted. In comparative experiment 2, the brightness of light exiting from the light guide plate 19 was measured while the vertex angle θv2 of each unit reflector 44a was fixed to a specific angle. The results are illustrated in FIGS. 11 and 12. Specifically, in comparative experiment 2, a comparative sample without the anisotropic reflection portion 44 was prepared. The comparative sample includes a reflection sheet having a flat reflection surface and the light reflection plate 19 that includes the lenticular lens portion 42. Furthermore, a sample having the following configuration was prepared. The sample includes the reflection sheet 40 that includes unit reflectors 44a each having the vertex angle θv2 set to 130° and the light guide plate 19 that includes lenticular lens portion 42. In the comparative sample and the sample, the LEDs 17 were turned on and the brightness levels of light exiting from the light guide plates 19 were measured. FIG. 11 illustrates brightness angle distributions of light exiting from the light guide plates with respect to the second direction. In FIG. 11, a solid line curve is related to the sample and a chain line curve is related to the comparative sample. In FIG. 11, the vertical axis represents relative brightness levels of light exiting from the light guide plate 19 (no unit) and the horizontal axis represents angles relative to the direction toward the front (in degrees (°)). In FIG. 11, the relative brightness levels represented by the vertical axis are expressed in relative values defined based on a reference (1.0) which corresponds to a brightness level in the direction toward the front (at an angle of 0°). FIG. 12 illustrates brightness distributions of light exiting from the light guide plate 19 with respect to the first direction (the X-axis direction). In FIG. 12, horizontally-long rectangular marks are related to the sample and diamond marks are related to the comparative sample. In FIG. 12, the vertical axis represents relative brightness levels of light exiting from the light guide plate 19 (no unit) and the horizontal axis represents position in the light guide plate 19 with respect to the first direction. In FIG. 12, the relative brightness levels represented by the vertical axis are expressed in relative values defined based on a reference (1.0) which corresponds to a highest brightness level of the comparative sample. In FIG. 12, the left end among the positions with respect to the first direction represented by the horizontal axis corresponds to the position of the light entrance surface 19b of the light guide plate 19 and the right end corresponds to the position of the opposite peripheral surface 19d of the light guide plate 19.

The results of comparative experiment 2 will be described. Regarding the brightness angle distributions of the light exiting from the light guide plate 19 with respect to the second direction, according to FIG. 11, the brightness levels of the sample and the comparative sample in an angle range relative to the direction toward the front (a range ±10° relative to the direction toward the front) are about equal. However, in a range from ±10° to ±50° relative to the direction toward the front, the brightness levels of the sample are higher than those of the comparative sample. Especially, the brightness levels of the light guide plate 19 in the sample are higher than those of the light guide plate 19 in the comparative sample in a range from ±20° to ±40° relative to the direction toward the front. As described earlier, the forward brightness of light exiting from the prism sheet 43 tends to be proportional to the number of rays of light exiting from the light guide plate 19 at angles in a range from ±23° to ±40°. In the sample, the light exiting from the light guide plate 19 and supplied to the prism sheet 43 includes a larger number of rays of light which travel at angles in the range from ±20° to ±40° relative to the direction toward the front. Therefore, the light exiting from the prism sheet 43 includes a larger number of rays that travel in directions at angles ±10° relative to the direction toward the front. Namely, the forward brightness of light exiting from the prism sheet 43 improves. Regarding the brightness distributions of the light exiting from the light guide plate with respect to the first direction, according to FIG. 12, the brightness levels of the sample are higher than those of the comparative sample for about the entire area. However, overall brightness distributions of the sample and the comparative sample are about the same. The anisotropic reflection portion 44 of the reflection sheet 40 in the sample is configured such that the rays of the reflected light are selectively angled with respect to the second direction but they are less likely to be angled with respect to the first direction. The reason why the sample has the brightness distributions similar to those of the comparative sample that includes the reflection sheet having the flat surface may be because of such a configuration. Namely, according to the configuration in which the reflection sheet 40 includes the anisotropic reflection portion 44 and the rays of the reflected light are selectively angled, the light from the light guide plate 19 includes a larger number of the rays for improving the brightness of the light exiting from the prism sheet 43 relative to the direction toward the front to improve the brightness directions with respect to the first direction while the brightness distributions with respect to the second direction are maintained.

As described earlier, the backlight unit (a lighting device) 12 according to this embodiment includes the LEDs (a light source) 17, the light guide plate 19, the reflection sheet (a reflection member) 40, the prism sheet (an anisotropic light collecting portion) 43, and the anisotropic reflection portion 44. The light guide plate 19 has a rectangular plate-like shape. One of the peripheral surfaces 19b and 19d that are opposed to each other is the light entrance surface 19b that is opposed to the LEDs 17. The plate surface is the light exit surface 19a through which light exits. The reflection sheet 40 includes the reflection surface that is opposed to the opposite plate surface (a plate surface) 19c opposite from the light exit surface 19a of the light guide plate. The reflection surface 40a is configured to reflect light from the light guide plate 19 with the reflection surface. The prism sheet 43 includes the unit prisms (unit light collectors) 43a that are farther from the light guide plate 19 than the reflection sheet 40 and each extending along the first direction. The first direction is along the peripheral surfaces 19e that are opposite from each other and do not include the light entrance surface 19b. The unit prisms 43a are arranged parallel to one another along the second direction. The second direction is along the peripheral surfaces 19b, 19d that include the light entrance surface 19b. The anisotropic reflection portion 44 is formed on the reflection surface 40a of the reflection sheet 40 and includes the unit reflectors 44a each extending in the first direction. The unit reflectors 44a are arranged parallel to one another in the second direction.

According to the configuration, the light emitted by the LEDs 17 enters the light guide plate 19 through the light entrance surface 19b and travels through the light guide plate 19 while reflected off the reflection surface 40a of the reflection sheet 40 that is disposed on the opposite side from the light exit surface 19a. Then, the light exits from the light exit surface 19a. The prism sheet 43 is disposed on the side of the light guide plate 19 opposite from the reflection sheet 40. With the prism sheet 43, the light collecting effects affect the rays of light exiting from the light exit surface 19a with respect to the second direction while the light collecting effects are less likely to affect the rays of light with respect to the first direction. The first direction is along the peripheral surfaces 19e of the light guide plate 19 opposite from each other and do not include the light entrance surface 19b. The second direction is along the peripheral surfaces 19b and 19d opposite from each other and including the light entrance surface 19b. Because the prism sheet 43 includes the unit prisms 43a that extend in the first direction and are arranged parallel to one another in the second direction, the light collecting effects selectively affect the rays of light exiting from the unit prisms 43a with respect to the second direction in which the unit prisms 43a are arranged.

The anisotropic reflection portion 44 configured to reflect light from the opposite plate surface 19c of the light guide plate 19 opposite from the light exit surface 19a includes the unit reflectors 44a that extend along the first direction and are arranged parallel to one another along the second direction. The rays of light from the light guide plate 19 are angled by the unit reflectors 44a with respect to the second direction in which the unit reflectors 44a are arranged. The rays of light are less likely to be angled with respect to the first direction in which the unit reflectors 44a extend and more likely to be reflected. The rays of light from the light exit surface of the light guide plate 19 toward the prism sheet 43 traveling in the second direction that corresponds with the light collecting direction of the unit prisms 43a are angled by the anisotropic reflection portion 44. Therefore, a larger number of rays of light which are more likely to exit from the unit prisms 43a of the prism sheet 43 without being reflected back in the directions from which the rays of light came are supplied to the unit prisms 43a. According to the configuration, the light use efficiency improves and the brightness of light exiting from the prism sheet 43 improves.

The prism sheet 43 includes the unit light collectors formed from the unit prisms 43a each having a triangular cross section. Because each of the unit prisms 43a that are the unit light collectors of the prism sheet 43 has a triangular cross section, the levels of the light collecting effects that affect to the exiting light can be adjusted according to the vertex angle θv1.

The lenticular lens portion 42 is formed on the light guide plate 19 opposite the prism sheet 43. The lenticular lens portion 42 includes the cylindrical lenses 42a that extend along the first direction and arranged parallel to one another along the second direction. According to the configuration, the rays of light are totally reflected within the cylindrical lenses 42a of the lenticular lens portion 42 such that the rays of light travel in the first direction in which the cylindrical lenses 42a extend. The rays of light are diffused in the first direction and the light collecting effects selectively affect the rays of light with respect to the second direction in which the cylindrical lenses 42a are arranged when exiting from the cylindrical lenses 42a. The rays of light exiting from the lenticular lens portion 42 are diffused in the first direction and the light collecting effects affect the rays of light with respect to the second direction. The rays of light in such conditions enter the prism sheet 43. A larger number of rays of light which are more likely to exit from the unit prisms 43a without being reflected back in the directions from which the rays of light came are supplied to the unit prisms 43a of the prism sheet 43. According to the configuration, the light use efficiency improves and the brightness of light exiting from the prism sheet 43 increases. Furthermore, uneven brightness is less likely to occur in the first direction.

The lenticular lens portion 42 is integrally formed with the light exit surface 19a of the light guide plate 19. According to the configuration, the rays of light traveling through the light guide plate 19 are totally reflected by the cylindrical lenses 42a before exiting from the light exit surface 19a so as to travel in the first direction in which the cylindrical lenses 42a extend. The rays of light are diffused with respect to the first direction. Therefore, the uneven brightness is less likely to occur in the light exiting from the light exit surface 19a. In comparison to a configuration in which the lenticular lens portion 42 is provided as a component separated from the light guide plate 19, the number of components is reduced. Namely, this configuration is advantageous for reducing the cost.

The prism sheet 43 includes the unit prisms 43a each having the vertex angle θv1 set to 90°. In comparison to the configuration in which the vertex angle θv1 set larger than 90° (obtuse angle), a larger number of rays of light are reflected back in the directions from which the rays of light came and the exit angle range of the exiting light is further limited by the unit prisms 43a. Stronger light collecting effects area achieved. This configuration is preferable for further improvement of the brightness.

The anisotropic reflector portion 44 includes the unit reflectors 44a each having a triangular cross section. Because each unit reflector 44a of the anisotropic reflection portion 44 has a rectangular cross section, the angles of the rays of light traveling in the second direction can be adjusted according to the vertex angle θv2 when the rays of light are reflected.

The anisotropic reflection portion 44 may include the unit reflectors 44a each having the vertex angle θv2 set in the range from 103° to 165°. According to the configuration, the brightness of light exiting from the prism sheet 43 improves in comparison to a configuration in which the vertex angle θv2 of each unit reflector 44a is set smaller than 103° or larger than 165°.

The anisotropic reflection portion 44 may include the unit reflectors 44a each having the vertex angle θv2 set in the range from 115° to 145°. According to the configuration, the brightness of light exiting from the prism sheet 43 further improves. In comparison to a configuration that includes the reflection sheet 40 having the reflection surface 40a instead of the anisotropic reflection portion 44, the brightness of the light exiting from the prism sheet 43 improves by 2% or more.

The anisotropic reflection portion 44 may include the unit reflectors 44a each having the vertex angle θv2 set in the range from 120° to 135°. According to the configuration, the brightness of light exiting from the prism sheet 43 further improves. In comparison to a configuration that includes the reflection sheet 40 having the reflection surface 40a instead of the anisotropic reflection portion 44, the brightness of the light exiting from the prism sheet 43 improves by 3% or more.

The anisotropic reflection portion 44 may include the unit reflectors 44a each having the vertex angle θv2 set to 130°. According to the configuration, the brightness of light exiting from the prism sheet 43 improves to a maximum level. In comparison to a configuration that includes the reflection sheet 40 having the reflection surface 40a instead of the anisotropic reflection portion 44, the brightness of the light exiting from the prism sheet 43 improves by 4% or more.

The reflection sheet 40 is configured to reflect light from the light guide plate 19 with the reflection surface 40a. The exiting light reflection portions 41 are formed in at least one of the opposite plate surface 19c of the light guide plate 19 opposite from the light exit surface 19a and the reflection surface 40a of the light exit surface 19a. The exiting light reflection portions 41 are configured to reflect the light such that the light exits from the light exit surface 19a. The areas of the exiting light reflection portions 41 increase as the distance from the LEDs 17 in the first direction increases. According to the configuration, the rays of light enter the light guide plate 19 through the light entrance surface 19b reflect off the reflection surface 40a of the reflection sheet 40 and travel through the light guide plate 19. The rays of light that travel through the light guide plate 19 are reflected by the exiting light reflection portions 41 formed in at least one of the opposite plate surface 19c of the light guide plate 19 opposite from the light exit surface 19a and the reflection surface 40a of the reflection sheet 40. According to the configuration, the rays of light are more likely to exit from the light exit surface 19a. The exiting light reflection portions 41 are configured such that the areas thereof increase as the distance from the LEDs 17 in the first direction increases. Therefore, the even amount of light exiting from the light exit surface 19a is achieved with respect to the first direction.

The liquid crystal display device (a display device) 10 according to this embodiment includes the backlight unit 12 having the configuration described above and the liquid crystal panel (a display panel) 11 configured to display images using light from the backlight unit 12. According to the liquid crystal display device 10 having such a configuration, the light exiting from the backlight unit 12 has the high brightness and thus the high display quality is achieved.

The display panel is the liquid crystal panel that includes liquid crystals sealed between the boards 11a and 11b. The liquid crystal display device 10 may be used in various applications including displays for smartphones and tablet computers.

### Second Embodiment

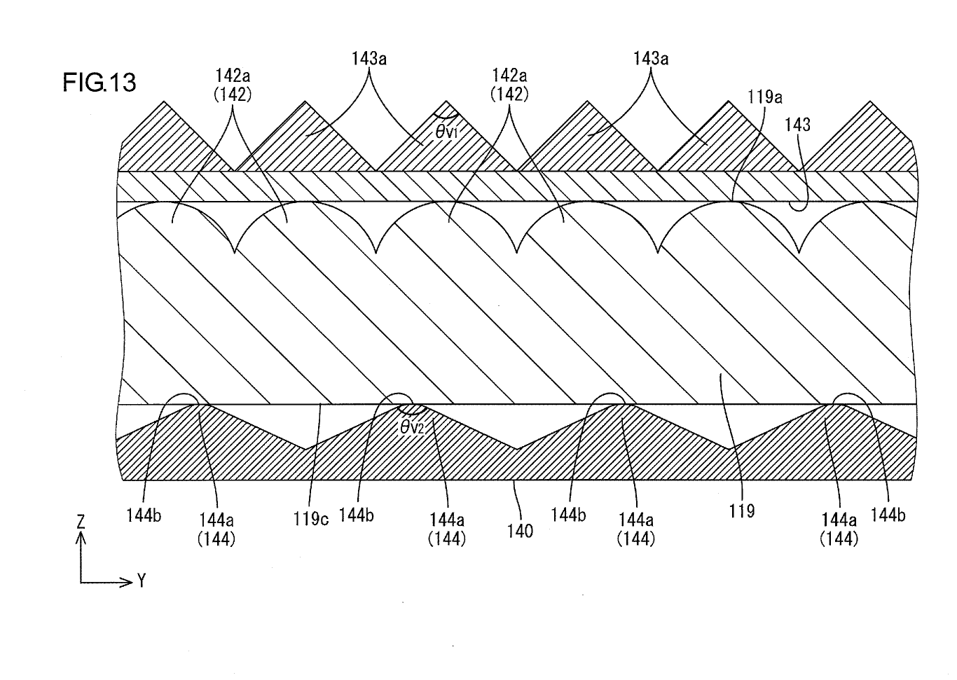

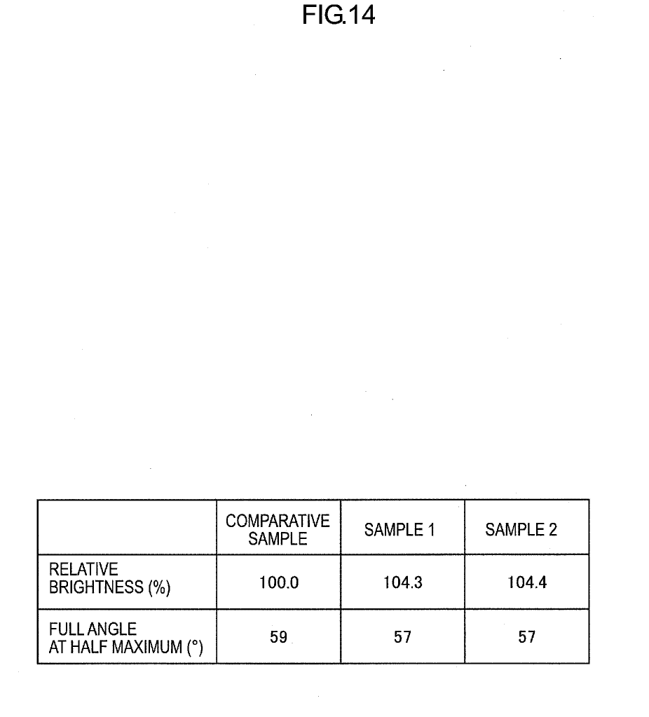

A second embodiment will be described with reference to FIGS. 13 and 14. The second embodiment includes an anisotropic reflection portion 144 that includes unit reflectors each having a shape different from the first embodiment. Structures, functions, and effects similar to those of the first embodiment will not be described.

As illustrated in FIG. 13, an isotropic reflection portion 144 of this embodiment includes unit reflectors 144a each including a rounded vertex 144b. Specifically, each unit reflector 144a has an isosceles triangular cross section cut along the second direction (the Y-axis direction) but the vertex 144b that is a projecting portion the closest to a light guide plate 119 has a rounded surface. A curvature radius of the vertex 144b of the unit reflector 144a is about 0.0059 mm. A vertex angle θv2 of each unit reflector 144a is about 130° as in the first embodiment. As described in the first embodiment section, the anisotropic reflection portion 144 includes the unit reflectors 144a arranged parallel to one another in the second direction. All unit reflectors 144a have rounded vertexes 144b. The vertex 144b of each unit reflector 144a is a portion of a reflection sheet 140 in direct contact with an opposite plate surface 119c of the light guide plate 119. With the rounded shape, the vertexes 144b are less likely to scratch the opposite peripheral surface 119c of the light guide plate 119 or the vertexes 144b are less likely to be deformed by the opposite plate surface 119c of the light guide plate 119. According to the configuration, optical performances of the light guide plate 119 and the reflection sheet 140 are less likely to decrease.

To find out how forward brightness of light exiting from the prism sheet varies with the vertexes 144b of the unit reflectors 144a having the rounded shape described above, comparative experiment 3 was conducted. In comparative experiment 3, a comparative sample, sample 1, and sample 2 were prepared. The comparative sample includes a reflection sheet having a flat reflection surface and does not include the anisotropic reflection portion 144. Sample 1 includes the reflection sheet 40 as in the first embodiment, that is, includes the anisotropic reflection portion 44 that includes the unit reflectors 44a each having the vertex angle set to 130° (see FIG. 6). Sample 2 includes the reflection sheet 140 as in this embodiment, that is, includes the anisotropic reflection portion 144 that includes the unit reflectors 144a each having the rounded vertex 144b. In comparative experiment 3, the light guide plates 119 including lenticular lens portions 142 on the front were disposed on the reflection sheets of the comparative sample, sample 1, and sample 2, respectively. Furthermore, prism sheets 143 including unit prisms 143a each having a vertex angle θv1 set to 90° were disposed in front of the light guide plates 119, respectively. The LEDs were turned on and brightness levels of light exiting from the prism sheets 143 were measured. The results are illustrated by a table in FIG. 14. The table in FIG. 14 contains relative brightness levels (in percent (%)) and full angles at half maximum (in degree (°)) of the light exiting from the prism sheets 143 with the reflections sheets of the comparative sample, sample 1, and sample 2. In FIG. 14, the relative brightness levels are expressed in relative values defined based on a reference (100%) which corresponds to a brightness level with the reflection sheet of the comparative sample. In FIG. 14, the full angles at half maximum represent an angle range in which the brightness levels of the exiting light are equal to half of the maximum level of the brightness (a brightness level relative to the maximum brightness level is 0.5). Regarding the full angles at half maximum, a value measured when the reflection sheet of the comparative sample was used is 59°, and this value is defined as a reference. If the results of comparative experiment 3 are smaller than the reference, a larger number of the rays of exiting light are collected to the direction toward the front, that is, the forward brightness is higher. If the results of comparative experiment 3 are larger than the reference, a larger number of the rays of exiting light are off the direction toward the front, that is, the forward brightness is lower.

The results of comparative experiment 3 will be described. According to FIG. 14, the relative brightness levels of samples 1 and 2 are higher than the relative brightness level of the comparative sample. Furthermore, the full angles at half maximum of samples 1 and 2 are smaller than the full angle at half maximum of the comparative sample. In comparison between samples 1 and 2, relative brightness levels are about equal and the full angles at half maximum are about equal. Namely, in comparison between the configuration that includes the unit reflectors 144a each having the rounded vertex 144b and the configuration that includes the unit reflectors 44a each having sharp vertex, the forward brightness of light exiting from the prism sheet 143 does not change. According to the configuration that includes the unit reflectors 144a each having the rounded vertex 144b, the light guide plate 119 and the unit reflectors 144a are less likely to be damaged without reducing the forward brightness of light exiting from the prism sheet 143.

As described above, this embodiment includes the anisotropic reflection portion 144 that includes the unit reflectors 144a each having the rounded vertex 144b. According to the configuration, when the vertexes 144b of the unit reflectors 144a of the anisotropic reflection portion 144 are brought into contact with the opposite plate surface 119c of the light guide plate 119 opposite from the light exit surface 119a, the opposite plate surface 119c of the light guide plate 119 are less likely to be scratched and the vertexes of the unit reflectors 144a are less likely to be deformed by the light guide plate. Therefore, the optical performances of the light guide plate 119 and the unit reflectors 144a are less likely to decrease.

The vertexes 144b of all unit reflectors 144a of the anisotropic reflection portion 144 are rounded. According to the configuration, the opposite plate surface 119c of the light guide plate 119 opposite from the light exit surface 119a is further less likely to be scratched. Therefore, the optical performances of the light guide plate 119 and the unit reflectors 144a are further less likely to decrease.

### Third Embodiment

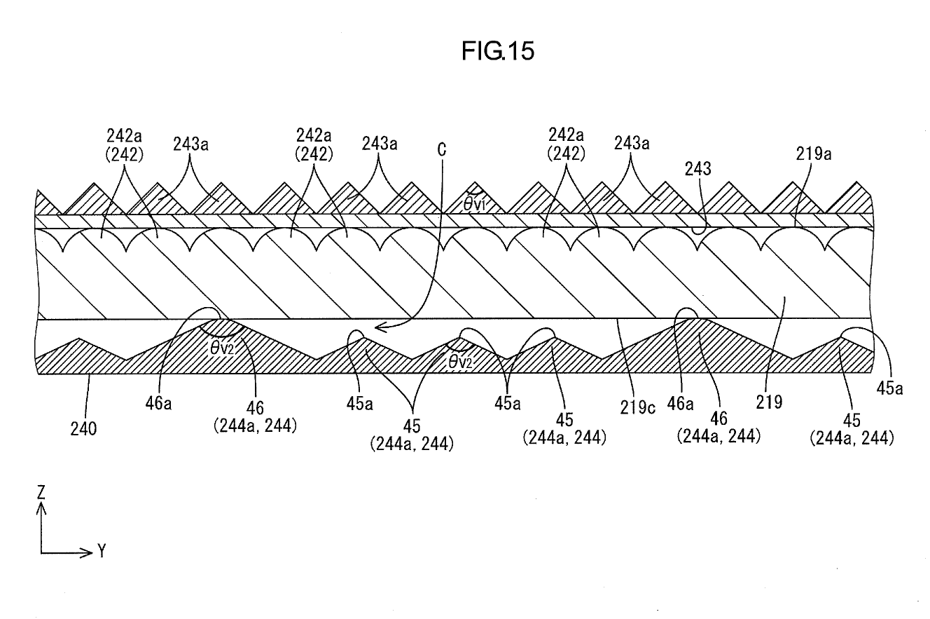

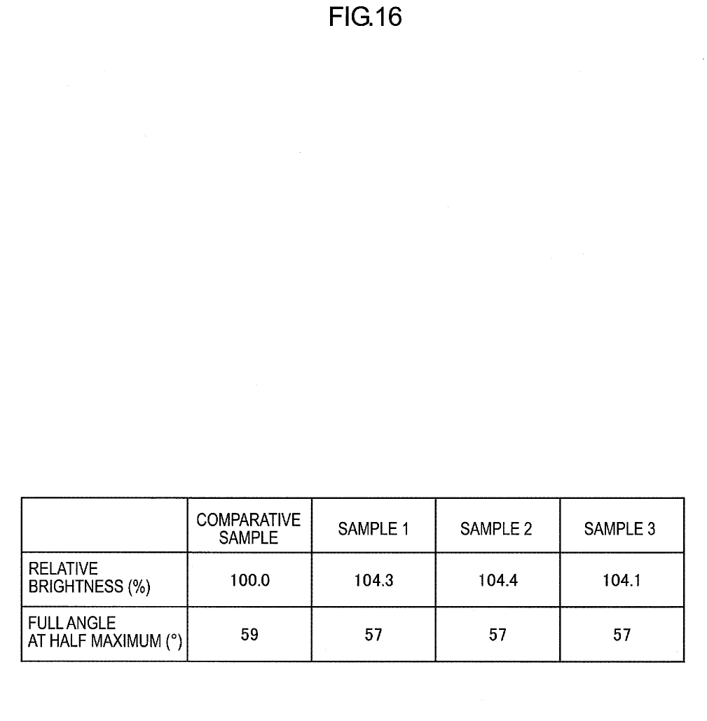

A third embodiment according to the present invention will be described with reference to FIGS. 15 and 16. The third embodiment includes an anisotropic reflection portion 244 that includes unit reflectors 244a each having a shape different from the first embodiment. Structures, functions, and effects similar to those of the first embodiment will not be described.

As illustrated in FIG. 15, the unit reflectors 244a of the anisotropic reflection portion 244 include first unit reflectors 45 and second unit reflectors 46. The first unit reflectors 45 include sharp vertexes 45a, respectively. The second unit reflectors 46 include rounded vertexes 46a, respectively. Each of the first unit reflectors 45 has a configuration the same as that of the unit reflector 44a of the first embodiment (see FIG. 6). Each of the second unit reflectors 46 has an isosceles triangular cross section cut along the second direction (the Y-axis direction) but the vertex 46a that is a projecting portion the closest to a light guide plate 219 has a rounded surface. A curvature radius of the vertex 46a of the unit reflector 244a is about 0.0059 mm. Each second unit reflector 46 has a height and a width larger than those of each first unit reflector 45. Specifically, the height and the width of the second unit reflector 46 are about twice larger than the height and the width of the first unit reflector 45, respectively. The vertexes 46a of the second unit reflectors 46 are directly in contact with the opposite plate surface 219c of the light guide plate 219. However, they are rounded and thus the opposite peripheral surface 219c of the light guide plate 219 are less likely to be scratched even if the vertexes 46a of the second unit reflectors 46 rub against the opposite plate surface 219c. Furthermore, the vertexes 46a are less likely to be deformed even if the opposite plate surface 219c of the light guide plate 219 touch the vertexes 46a of the second unit reflectors 46. Therefore, the optical performances of the light guide plate 219 and the reflection sheet 240 are less likely to decrease. Furthermore, clearances C are provided between the first unit reflectors 45 and the opposite plate surface 219c of the light guide plate 219. Each clearance C has a size about equal to the height of the first unit reflector 45. Therefore, the first unit reflectors 45 are maintained without being in contact with the opposite plate surface 219c of the light guide plate 219. In comparison to the second embodiment, the contact area between the light guide plate 219 and the anisotropic reflection portion 244 is smaller. With air layers in the clearances C between the light guide plate 219 and the anisotropic reflection portion 244, the light guide plate 219 and the anisotropic reflection portion 244 are less likely to be in close contact with each other. The second unit reflectors 46 are arranged at intervals along the second direction that corresponds with the arrangement direction of the unit reflectors 244a. Specifically, three first unit reflectors 45 are arranged between the adjacent second unit reflectors 46. According to the configuration in which the second unit reflectors 46 are arranged at constant intervals (every three first unit reflectors 45), the clearances C between the first unit reflectors 45 and the opposite plate surface 219c of the light guide plate 219 remain stable. Specifically, a distance between centers of the adjacent second unit reflectors 46 is about 0.04 mm. The vertex angle θv2 of each second unit reflector 46 is about equal to the vertex angle θv2 of each first unit reflector 45, which is about 130°.

Next, to find out how forward brightness of light exiting from the prism sheet 243 varies with the reflection sheet 240 that the anisotropic reflection portion 244 described above, comparative experiment 4 was conducted. The anisotropic reflection portion 244 includes the first unit reflectors 45 that include the sharp vertexes 45a and the second unit reflectors that include the rounded vertexes 46a, which are mixedly arranged. In comparative experiment 4, a comparative sample, sample 1, sample 2, and sample 3 were prepared. The comparative sample includes a reflection sheet having a flat reflection surface and does not include the anisotropic reflection portion 244. Sample 1 includes the reflection sheet 40 as in the first embodiment, that is, includes the anisotropic reflection portion 44 that includes the unit reflectors 44a each having the vertex angle set to 130° (see FIG. 6). Sample 2 includes the reflection sheet 240 as in the second embodiment, that is, includes the anisotropic reflection portion 244 that includes the unit reflectors 244a each having the rounded vertex 244b (see FIG. 13). Sample 3 includes the reflection sheet 240 that includes the anisotropic reflection portion 244. The anisotropic reflection portion 244 includes the first unit reflectors 45 each having the sharp vertex 45a and the second unit reflectors 46 each having the rounded vertex 46a, which are mixedly arranged. In comparative experiment 4, the light guide plates 219 including lenticular lens portions 242 on the front were disposed on the reflection sheets of the comparative sample, sample 1, sample 2, and sample 3, respectively. Furthermore, prism sheets 243 including unit prisms 243a each having a vertex angle θv1 set to 90° were disposed in front of the light guide plates 219, respectively. The LEDs were turned on and brightness levels of light exiting from the prism sheets 243 were measured. The results are illustrated by a table in FIG. 16. The table in FIG. 16 contains relative brightness levels (in percent (%)) and full angles at half maximum (in degree (°)) of the light exiting from the prism sheets 243 with the reflections sheets of the comparative sample, sample 1, sample 2, and sample 3. In FIG. 16, the relative brightness levels are expressed in relative values defined based on a reference (100%) which corresponds to a brightness level with the reflection sheet of the comparative sample. In FIG. 16, the full angles at half maximum represent an angle range in which the brightness levels of the exiting light are equal to half of the maximum level of the brightness (a brightness level relative to the maximum brightness level is 0.5). Regarding the full angles at half maximum, a value measured when the reflection sheet of the comparative sample was used is 59°, and this value is defined as a reference. If the results of comparative experiment 4 are smaller than the reference, a larger number of the rays of exiting light are collected to the direction toward the front, that is, the forward brightness is higher. If the results of comparative experiment 4 are larger than the reference, a larger number of the rays of exiting light are off the direction toward the front, that is, the forward brightness is lower.

The results of comparative experiment 4 will be described. According to FIG. 16, the relative brightness levels of the samples 1 to 3 are higher than the brightness level of the comparative sample. Furthermore, the full angles at half maximum are smaller than the full angle at half maximum of the comparative sample. In comparison between sample 3 and sample 1 or sample 2, the relative brightness levels are about equal and the full angles at half maximum are about equal. The forward brightness of light exit from the prism sheet 243 in the configuration in which the anisotropic reflection portion 244 includes the unit reflectors 244a that includes the first unit reflectors 45 each having the sharp vertex 45a and the second unit reflectors 46 each having the rounded vertex 46a, which are mixedly arranged, does not differ from the forward brightness in the configuration in which all unit reflectors 144a have the rounded vertexes 144b or all unit reflectors 44a have the sharp vertexes 44a. According to the configuration in which the unit reflectors 244a of the anisotropic reflection portion 244 include the first unit reflectors 45 each having the sharp vertex 45a and the second unit reflectors 46 each having the rounded vertex 46a, which are mixedly arranged, the light guide plate 219 and the unit reflectors 244a are less likely to be scratched without reducing the forward brightness of light exiting from the prism sheet 243. Furthermore, the light guide plate 219 and the anisotropic reflection portion 244 are less likely to be in close contact with each other.

As described above, this embodiment includes the anisotropic reflection portion 244 that includes the second unit reflectors (unit reflectors) 46 each having the rounded vertex 46a and the first unit reflectors (unit reflectors) 45 each having the sharp vertex 45a, which are mixedly arranged. The second unit reflectors 46 each having the rounded vertex 46a are arranged at intervals such that the first unit reflectors 45 each having the sharp vertex 45a are arranged therebetween with respect to the second direction. Furthermore, the second unit reflectors 46 each having the rounded vertex 46a are arranged closer to the light guide plate 219 than the first unit reflectors 45 each having the sharp vertex 45a. Because the second unit reflectors 46 each having the rounded vertex 46a are arranged closer to the light guide plate 219 than the first unit reflectors 45 each having the sharp vertex 45a, the clearances C are provided between the first unit reflectors 45 each having the sharp vertex 45a and the opposite plate surface 219c of the light guide plate 219 opposite from the light exit surface 219a. According to the configuration, the contact area between the light guide plate 219 and the anisotropic reflection portion 244 decreases and thus they are less likely to be in close contact with each other. Furthermore, because the second unit reflectors 46 each having the rounded vertex 46a are arranged at intervals such that the first unit reflectors 45 each having the sharp vertex 45a are arranged therebetween with respect to the second direction, the positional relationships between the unit reflectors 244a and the light guide plate 219 remain stable.

### Fourth Embodiment

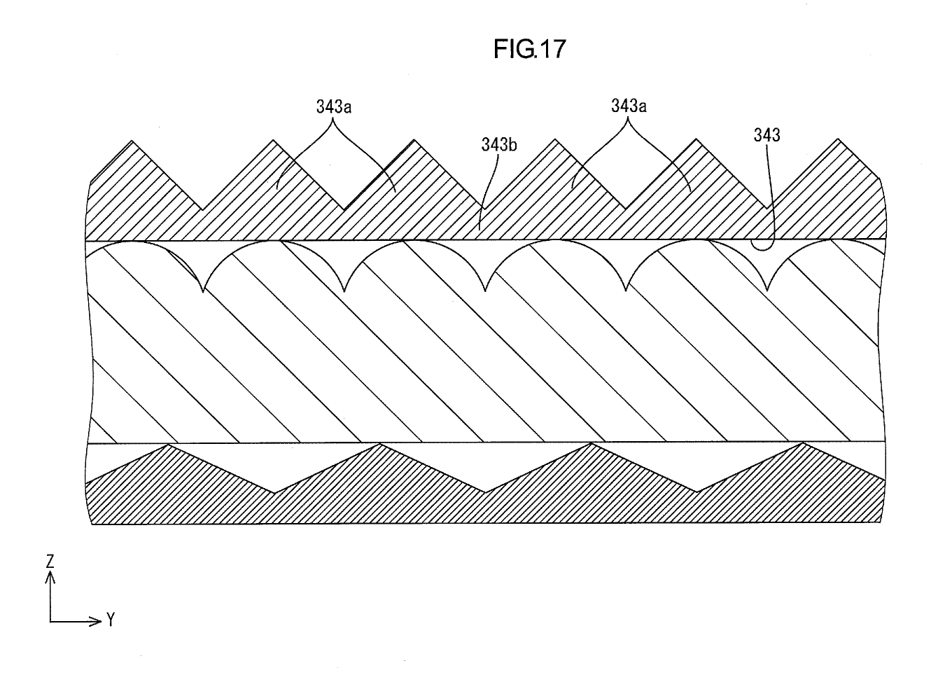

A fourth embodiment according to the present invention will be described with reference to FIG. 17. The fourth embodiment includes a prism sheet 343 having a configuration different from the first embodiment. Structures, functions, and effects similar to those of the first embodiment will not be described.

As illustrated in FIG. 17, the prism sheet 343 of this embodiment includes unit prisms 343a and a base 343b are made of the same material and integrally formed. The prism sheet 343 may be made of polycarbonate (PC) having a refractive index of about 1.59. According to the configuration, functions and effects similar to those of the first embodiment are achieved.

### Fifth Embodiment

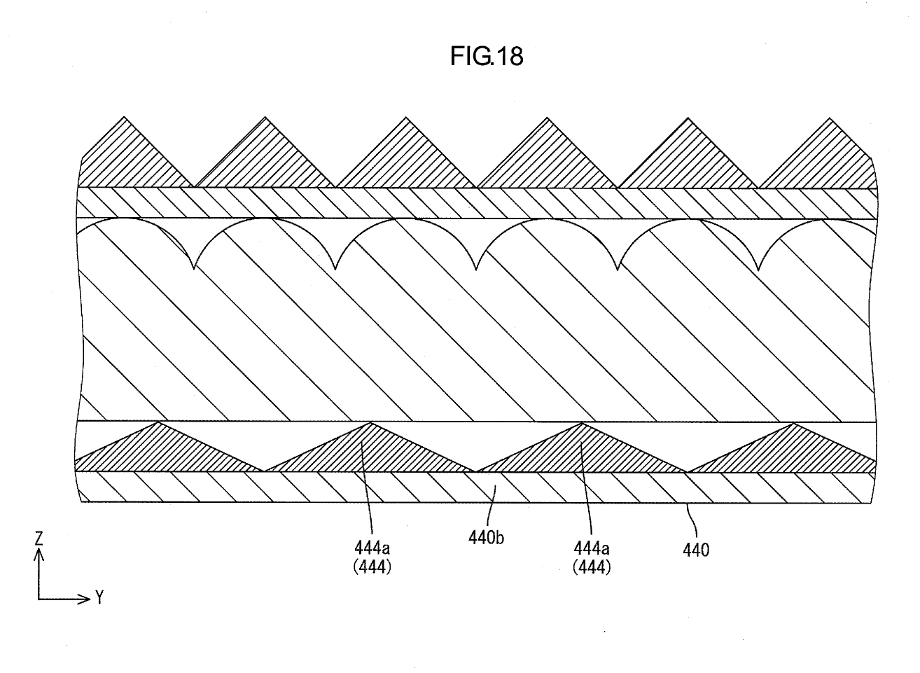

A fifth embodiment according to the present invention will be described with reference to FIG. 18. The fifth embodiment includes a reflection sheet 440 having a configuration different from the first embodiment. Structures, functions, and effects similar to those of the first embodiment will not be described.

As illustrated in FIG. 18, the reflection sheet 440 of this embodiment include an anisotropic reflection portion 444 (unit reflectors 444a) and a reflection base 440b made of different material. The anisotropic reflection portion 444 is integrally formed with a front plate surface of the reflection base 440b. The anisotropic reflection portion 444 may be made of material having surface light reflectivity higher than a material of the reflection base 440b. According to the configuration, functions and effects similar to those of the first embodiment are achieved.

### Other Embodiment

The present invention is not limited to the above embodiments described with reference to the drawings. The following embodiments may be included in the technical scope of the present invention.

(1) In each of the above embodiments, the lenticular lens portion is integrally formed with the light exit surface of the light guide plate. The lenticular lens portion may be prepared as a component separately from the light guide plate and layered on the light exit surface of the light guide plate. In such a configuration, it is preferable that the refractive index of the material of the lenticular lens portions prepared as a separate component is equal to the refractive index of the material of the light guide plate. Furthermore, it is preferable that the material of the lenticular lens prepared as a separate component and the material of the light guide plate are the same.

(2) In each of the above embodiments, the prism sheet includes the unit prisms having the same height and the same width (or interval). The prism sheet may include two or more kinds of unit prisms having different heights and/or different widths. If the heights and the widths of the unit prisms are randomly defined, the moire reducing effect may be achieved.

(3) The thicknesses of the reflection bases of the reflection sheets and the heights and/or widths (or intervals) of the unit reflectors may be altered from those in the drawings related to the embodiments.

(4) The sizes including thicknesses of the bases and the heights and the widths (or intervals) of the unit prisms may be altered from those in the above embodiments and the drawings as appropriate. The sizes including the thickness of the light guide plate and the heights and the widths (or intervals) of the cylindrical lenses of the lenticular lenses may be altered as appropriate.

(5) Relationships among the height and the width (or the interval) of each unit prism of the prism sheet, the height and the width of each cylindrical lens of the lenticular lens portion, the height and the width of each unit reflector of the anisotropic reflection portion of the reflection sheet may be altered from those of each embodiment described earlier. For example, the height or the width of the unit reflector may be defined equal to the height or the width of the unit prism or the height or the width of the cylindrical lens. Furthermore, the height and the width of the unit prism may be defined differently from the height and the width of the cylindrical lens.

(6) In each of the above embodiments, the reflection sheet includes the anisotropic reflection portion, all unit reflectors of which have the equal vertex angles. However, a reflection sheet that includes an anisotropic reflection portion including unit reflectors having different vertex angles may be used.

(7) In each of the above embodiments, each unit reflector of the anisotropic reflection portion has the triangular cross section and the sloped surfaces that define the vertex angle are flat surfaces. However, the sloped surfaces of the unit reflector may be curved or waved. The curved surfaces may be convex surfaces or concave surfaces.

(8) In each of the above embodiments, the lenticular lens portion is formed on the light exit surface of the light guide plate. However, the lenticular lens portion may be omitted.

(9) In the second embodiment, the vertexes of all unit reflectors of the anisotropic reflection portion having the same height and the same width are rounded. However, the vertexes of only some of the unit reflectors of the anisotropic reflection portion having the same height and the same width may be rounded and others may be sharp vertexes.

(10) In the third embodiments, three first unit reflectors are arranged between the adjacent second unit reflectors. However, the number of the first unit reflector arranged between the adjacent second unit reflectors can be altered as appropriate.

(11) In the third embodiments, the height and the width of each second unit reflector are twice larger than the height and the width of each first unit reflector. However, the height and the width of the second unit reflector may be altered as appropriate. For example, the height of the second unit reflector may be larger than that of the first unit reflector but the width of the second unit reflector may be equal to that of the first unit reflector. In that case, the vertex angle of the first unit reflector and the vertex angle of the second unit reflector may be different from each other.

(12) The prism sheet of the fourth embodiment and the reflection sheet of the fifth embodiment may be used in combination.

(13) In each of the above embodiments, the unit exiting light reflection grooves for guiding light are formed in the opposite surface of the light guide plate. However, the exiting light reflection portion may be formed by printing unit exiting light reflection patterns on a surface of a reflection sheet for scattering and reflecting light. Alternatively, the exiting light reflection portion may be formed by printing unit exiting light reflection patterns on the opposite plate surface of the light guide plate configured as a flat surface for reflecting light by the unit exiting light reflection patterns.

(14) In each of the above embodiments, the optical sheet includes only one prism sheet. The optical sheet may include other optical sheets (e.g., other prism sheet, a diffuser sheet, and a reflective polarizing sheet).

(15) In each of the above embodiments, a single LED board is disposed along the light entrance surface of the light guide plate. However, two or more LED boards may be disposed along the light entrance surface of the light guide plate.

(16) In each of the above embodiments, one of the short peripheral surfaces of the light guide plate is configured as a light entrance surface and the LED board is disposed opposite the light entrance surface. However, one of the long peripheral surfaces of the light guide plate may be configured as a light entrance surface and the LED board may be disposed opposite the light entrance surface. The direction in which the unit prisms of the prism sheets, the cylindrical lenses of the lenticular lens portion of the light guide plate, and the unit reflectors of the anisotropic reflection portion of the reflection sheet extend may be aligned with the short-side direction of the light guide plate. Furthermore, the direction in which the unit prisms, the cylindrical lenses, and the unit reflectors are arranged may be aligned with the long-side direction of the light guide plate.

(17) Other than embodiment (16), a configuration in which both short peripheral surfaces are configured as light entrance surfaces and LED boards are disposed opposite the short peripheral surfaces, respectively, may be included in the scope of the present invention. Furthermore, a configuration in which both long peripheral surfaces are configured as light entrance surfaces and LED boards are disposed opposite the long peripheral surfaces, respectively, may be included in the scope of the present invention.

(18) In each of the above embodiments, the top surface light emitting type LEDs are used. However, the present invention may be applied to a configuration that includes side surface light emitting LEDs. The side surface light emitting LED includes a side surface adjacent to the mounting surface that is mounted to the LED board and configured as a light emitting surface.

(19) In each of the above embodiments, the touchscreen pattern using the projected capacitive touchscreen technology is used. Other than that, the present invention may be applied to configurations that include a touchscreen pattern using the surface capacitive touchscreen technology, a touchscreen pattern using the resistive touchscreen technology, and a touchscreen pattern using the electromagnetic induction touchscreen technology, respectively.

(20) Instead of the touchscreen in each of the above embodiments, parallax barrier panel (a switching liquid crystal panel) including parallax barrier patterns may be used. The parallax barrier patterns are for separating images displayed on the liquid crystal panel with a parallax so that a user sees stereoscopic images (3D images, three-dimensional images). The parallax barrier panel may be used in combination with the touchscreen panel.

(21) Touchscreen patterns may be formed on the parallax barrier panel in embodiment (20) to add touchscreen functions to the parallax barrier panel.

(22) In each of the above embodiments, the liquid crystal panel of the liquid crystal display device has the screen size of about 20 inches. The screen size of the liquid crystal panel may be altered as appropriate. Liquid crystal panel having a screen size of some inches may be used for an electronic device such as a smartphone.

(23) In each of the above embodiments, the color portions of the color filters of the liquid crystal panel are in three colors of R, G and B. The color portions may be in four or more colors.

(24) In each of the above embodiments, the LEDs are used as light sources. However, organic ELs or other types of light sources may be used.

(25) In each of the above embodiments, the frame is made of metal. However, the frame may be made of synthetic resin.

(26) In each of the above embodiments, the chemically toughened glass is used for the cover panel. However, a toughened glass with an air-cooling toughening process (a physically toughening process) performed thereon may be used.

(27) In each of the above embodiments, the chemically toughened glass is used for the cover panel. However, a regular glass (non-toughened glass) other than the toughened glass or a synthetic resin member may be used.

(28) In each of the above embodiments, the cover panel is used for the liquid crystal display device. However, the cover panel may not be used. Furthermore, the touchscreen panel may not be used.

(29) In each of the above embodiments, the edge light-type backlight unit is used in the liquid crystal display device. However, a liquid crystal display device that includes a direct back light unit may be included in the scope of the present invention.

(30) Each of the above embodiments includes the TFTs as switching components of the liquid crystal display device. However, switching components other than the TFTs (such as thin film diodes (TFDs)) may be included in the scope of the present invention. Furthermore, a liquid crystal display device configured to display black and white images other than the liquid crystal display device configured to display color images.

### EXPLANATION OF SYMBOLS

10: Liquid crystal display device (a display device)
11: Liquid crystal panel (a display panel)
11a, 11b: Board
12: Backlight unit (a lighting device)
17: LED (a light source)
19, 119, 219: Light guide plate
19a, 119a, 219a: Light exit surface
19b: Light entrance surface
19c, 119c, 219c: Opposite plate surface (a plate surface)
19d: Opposite peripheral surface (peripheral surfaces including the light entrance surface)
19e: Peripheral surface (peripheral surfaces not including the light entrance surface)
40, 140, 240, 440: Reflection sheet (a reflection member)
40a: Reflection surface
42, 142, 242: Lenticular lens portion
42a, 142a, 242a: Cylindrical lens
43, 143, 243, 343: Prism sheet (an anisotropic light collecting portion)
43a, 143a, 243a, 343a: Unit prism (a unit light collector)
44, 144, 244, 444: Anisotropic reflection portion
44a, 144a, 244a, 444a: Unit reflector
45: First unit reflector (a unit reflector)
45a: Vertex
46: Second unit reflector (a unit reflector)
46a: Vertex
144b: Vertex
C: Clearance
θv1: Vertex angle
θv2: Vertex angle

1. A lighting device comprising:
a light source;
a light guide plate having a rectangular plate-like shape and including peripheral surfaces opposite from each other and plate surfaces, at least one of the peripheral surfaces being configured as a light entrance surface opposite the light source, one of the plate surfaces is configured as a light exit surface;
a reflection member including a reflection surface opposed to the plate surface of the light guide plate opposite from the light exit surface and configured to reflect light from the light guide plate with the reflection surface;
an anisotropic light collecting portion formed on a side of the light guide plate opposite from a side on which the reflection member is disposed and including unit light collectors extending along a first direction that is along peripheral surfaces of the light guide plate not including the light entrance surface, the unit light collectors being arranged parallel to one another along a second direction along the peripheral surfaces including the light entrance surface; and
an anisotropic reflection portion including unit reflectors disposed on the reflection surface of the reflection member, each of the unit reflectors extending along the first direction, the unit reflectors being arranged parallel to one another along the second direction.

2. The lighting device according to claim 1, wherein the unit light collectors of the anisotropic light collecting portion are unit prisms each having a triangular cross section.

3. The lighting device according to claim 2, further comprising a lenticular lens portion on the light guide plate opposite the anisotropic light collecting portion, the lenticular lens portion including cylindrical lenses that extend along the first direction and arranged parallel to one another along the second direction.

4. The lighting device according to claim 3, wherein the lenticular lens portion is integrally formed with the light exit surface of the light guide plate.

5. The lighting device according to claim 1, wherein each of the unit light collectors of the anisotropic light collecting portion has a vertex angle set to 90°.

6. The lighting device according to claim 1, wherein each of the unit reflectors of the anisotropic reflection portion has a triangular cross section.

7. The lighting device according to claim 6, wherein each of the unit reflectors of the anisotropic reflection portion has a vertex angle set in a range from 103° to 165°.

8. The lighting device according to claim 6, wherein each of the unit reflectors of the anisotropic reflection portion has a vertex angle set in a range from 115° to 145°.

9. The lighting device according to claim 6, wherein each of the unit reflectors of the anisotropic reflection portion has a vertex angle set in a range from 120° to 135°.

10. The lighting device according to claim 6, wherein each of the unit reflectors of the anisotropic reflection portion has a vertex angle set to 130°.

11. The lighting device according to claim 6, wherein some of the unit reflectors of the anisotropic reflection portion include rounded vertexes.

12. The lighting device according to claim 11, wherein all of the unit reflectors of the anisotropic reflection portion have rounded vertexes.

13. The lighting device according to claim 11, wherein
the anisotropic reflection portion includes the unit reflectors that include the rounded vertexes and the unit reflectors that include sharp vertexes, which are mixedly arranged; and
the unit reflectors that include the rounded vertexes are arranged at intervals such that the unit reflectors that include the sharp vertexes therebetween with respect to the second direction and the vertexes of the unit reflectors that include the rounded vertexes are located closer to the light guide plate than those of the unit reflectors that include the sharp vertexes.

14. A display device comprising:
the lighting device according to claim 1; and
a display panel for displaying an image using light from the lighting device.

15. The display device according to claim 14, wherein the display panel is a liquid crystal panel including liquid crystals sealed between boards.
